(19) United States
(12) Patent Application Publication
(10) Pub. No.: US 2026/0111781 A1
(43) Pub. Date: Apr. 23, 2026

(54) LAYOUT OPTIMIZATION OF ERROR CORRECTION IN MEASUREMENT-BASED QUANTUM COMPUTING

(71) Applicant: Classiq Technologies LTD., Tel Aviv (IL)

(72) Inventors: Amir Naveh, Haifa (IL); Shmuel Ur, Shorashim (IL); Ron Cohen, Givataim (IL); Eyal Cornfeld, Ramat Gan (IL); Yehuda Naveh, Tel-Aviv Yafo (IL); Nati Erez, Kfar Yona (IL)

(21) Appl. No.: 18/924,047

(22) Filed: Oct. 23, 2024

(51) Int. Cl. G06N 10/40; G06N 10/20

(52) U.S. Cl. CPC G06N 10/40; G06N 10/20

(57) ABSTRACT

A method, apparatus, and product comprising: obtaining a logical representation of a quantum program that comprises logical qubits and gate operations; converting the logical representation to a physical representation to be executed on a measurement-based quantum computer, said converting comprising: determining a segmentation of quantum sources into disjoint segments configured to generate consecutive layers of clusters of physical qubits separated by time delays; selecting for each segment an interleaving depth, said selecting comprises selecting a non-uniform distribution of interleaving depths between first and second disjoint segments; and allocating for each segment one or more logical qubits to be represented by the each segment; and synthesizing the quantum program according to the physical representation.

### TECHNICAL FIELD

The present disclosure relates to quantum computing in general, and to error correction in measurement-based quantum computing, in particular.

### BACKGROUND

Quantum computing is a computational paradigm that is fundamentally different from classic computing. In contrast to classic computing, which utilizes bits, quantum computing utilizes qubits. The qubits may possess unique features, as each qubit can be in superposition, several qubits can be entangled, and all operations on qubits besides measurement (referred to as quantum gates) must be reversible except for measurements.

Quantum circuits may be implemented in various forms, e.g., as Measurement-Based Quantum Computing (MBQC) circuits, circuit-based quantum computing circuits, or the like. In some exemplary embodiments, MBQC circuits, for instance, may leverage one or more types of quantum hardware, such as optical components, Linear Optic Quantum Computation (LOQC) components, or the like.

A critical aspect of quantum computing is Quantum Error Correction (QEC), which may be configured to protect quantum information from errors caused by decoherence and other quantum noise. Effective error correction is essential for maintaining the integrity of stored quantum information.

### BRIEF SUMMARY

One exemplary embodiment of the disclosed subject matter is a method comprising: obtaining a logical representation of a quantum program, wherein the logical representation comprises a plurality of logical qubits, wherein the logical representation defines a plurality of gate operations on subsets of the plurality of logical qubits; converting the logical representation to a physical representation of the quantum program that is configured to be executed on a measurement-based quantum computer, wherein said converting comprises: determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time; selecting, for each segment of the plurality of disjoint segments, an interleaving depth from a plurality of interleaving depths supported by the measurement-based quantum computer, the plurality of interleaving depths corresponding to a respective plurality of lengths of delay lines between non-consecutive layers generated by each segment, wherein said selecting the interleaving depth comprises selecting a first interleaving depth for non-consecutive layers of a first segment of the plurality of disjoint segments, and selecting a second interleaving depth for non-consecutive layers of a second segment of the plurality of disjoint segments, the first and second interleaving depths are different, thereby obtaining a non-uniform distribution of interleaving depths between the plurality of disjoint segments; and allocating, for each segment of the plurality of disjoint segments, one or more logical qubits of the plurality of logical qubits to be represented by each segment, wherein said allocating the one or more logical qubits is performed based on interleaving depths of the plurality of disjoint segments; and synthesizing the quantum program according to the physical representation, whereby a synthesized quantum program is executable on the measurement-based quantum computer.

Optionally, said allocating the one or more logical qubits comprises allocating, for a logical qubit of the plurality of logical qubits, a respective cluster ensemble from one or more non-consecutive layers generated by the first segment, the cluster ensemble comprises a set of clusters of physical qubits from the one or more non-consecutive layers, the one or more non-consecutive layers are interleaved according to the first interleaving depth.

Optionally, the one or more non-consecutive layers comprise a set of non-consecutive layers, wherein each two adjacent layers of the set are separated by at least one layer of clusters of physical qubits.

Optionally, the at least one layer of clusters comprises one of: a single layer, a pair of successive layers, or three successive layers.

Optionally, fusion operations are enabled between each two adjacent layers of the set due to the delay lines.

Optionally, said converting is performed according to an optimization function, wherein the optimization function is configured to minimize at least one of: a quantity of the plurality of quantum sources that are allocated to the plurality of disjoint segments, a number of cycles required for executing the synthesized quantum program on the measurement-based quantum computer, or an error rate of the synthesized quantum program.

Optionally, said converting comprises allocating fusion processes to implement the plurality of gate operations, the fusion processes comprising at least one of: fusion gates, or unitary gates, wherein the allocation of fusion processes affects a number of cycles required for executing the synthesized quantum program.

Optionally, said allocating the one or more logical qubits comprises allocating, for a first logical qubit of the plurality of logical qubits, a first cluster ensemble generated by the first segment, and allocating, for a second logical qubit of the plurality of logical qubits, a second cluster ensemble generated by the first segment, wherein said allocating the fusion processes comprises allocating a fusion process between the first and second cluster ensembles.

Optionally, said allocating the one or more logical qubits comprises allocating, for a first logical qubit of the plurality of logical qubits, a first cluster ensemble generated by the first segment, and allocating, for a second logical qubit of the plurality of logical qubits, a second cluster ensemble generated by a second segment, wherein said allocating the fusion processes comprises allocating a fusion process between the first and second cluster ensembles.

Optionally, said converting comprises allocating fusion processes to implement surface code measurements every defined period.

Optionally, the plurality of the lengths of the delay lines are longer for greater interleaving depths and shorter for lesser interleaving depths, wherein the delay lines comprise optical fibers.

Optionally, the first segment comprises a first numbers of quantum sources and the second segment comprises a second numbers of quantum sources, the first number of quantum sources different from the second number of quantum sources.

Optionally, the method comprises executing the synthesized quantum program on the measurement-based quantum computer.

Optionally, the measurement-based quantum computer comprises a photonic quantum computer, and the physical qubits comprise optical qubits.

Another exemplary embodiment of the disclosed subject matter is an apparatus comprising a processor and coupled memory, said processor being adapted to perform: obtaining a logical representation of a quantum program, wherein the logical representation comprises a plurality of logical qubits, wherein the logical representation defines a plurality of gate operations on subsets of the plurality of logical qubits; converting the logical representation to a physical representation of the quantum program that is configured to be executed on a measurement-based quantum computer, wherein said converting comprises: determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time; selecting, for each segment of the plurality of disjoint segments, an interleaving depth from a plurality of interleaving depths supported by the measurement-based quantum computer, the plurality of interleaving depths corresponding to a respective plurality of lengths of delay lines between non-consecutive layers generated by each segment, wherein said selecting the interleaving depth comprises selecting a first interleaving depth for non-consecutive layers of a first segment of the plurality of disjoint segments, and selecting a second interleaving depth for non-consecutive layers of a second segment of the plurality of disjoint segments, the first and second interleaving depths are different, thereby obtaining a non-uniform distribution of interleaving depths between the plurality of disjoint segments; and allocating, for each segment of the plurality of disjoint segments, one or more logical qubits of the plurality of logical qubits to be represented by each segment, wherein said allocating the one or more logical qubits is performed based on interleaving depths of the plurality of disjoint segments; and synthesizing the quantum program according to the physical representation, whereby a synthesized quantum program is executable on the measurement-based quantum computer.

Yet another exemplary embodiment of the disclosed subject matter is a computer program product comprising a non-transitory computer readable medium retaining program instructions, which program instructions, when read by a processor, cause the processor to perform: obtaining a logical representation of a quantum program, wherein the logical representation comprises a plurality of logical qubits, wherein the logical representation defines a plurality of gate operations on subsets of the plurality of logical qubits; converting the logical representation to a physical representation of the quantum program that is configured to be executed on a measurement-based quantum computer, wherein said converting comprises: determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time; selecting, for each segment of the plurality of disjoint segments, an interleaving depth from a plurality of interleaving depths supported by the measurement-based quantum computer, the plurality of interleaving depths corresponding to a respective plurality of lengths of delay lines between non-consecutive layers generated by each segment, wherein said selecting the interleaving depth comprises selecting a first interleaving depth for non-consecutive layers of a first segment of the plurality of disjoint segments, and selecting a second interleaving depth for non-consecutive layers of a second segment of the plurality of disjoint segments, the first and second interleaving depths are different, thereby obtaining a non-uniform distribution of interleaving depths between the plurality of disjoint segments; and allocating, for each segment of the plurality of disjoint segments, one or more logical qubits of the plurality of logical qubits to be represented by each segment, wherein said allocating the one or more logical qubits is performed based on interleaving depths of the plurality of disjoint segments; and synthesizing the quantum program according to the physical representation, whereby a synthesized quantum program is executable on the measurement-based quantum computer.

One exemplary embodiment of the disclosed subject matter is a method comprising: obtaining a logical representation of a quantum program, wherein the logical representation comprises a plurality of logical qubits, wherein the logical representation defines a plurality of gate operations on subsets of the plurality of logical qubits; converting the logical representation to a physical representation of the quantum program that is configured to be executed on a measurement-based quantum computer, wherein said converting is performed according to an optimization function, wherein said converting comprises: determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time; allocating, for each segment of the plurality of disjoint segments, one or more logical qubits of the plurality of logical qubits to be represented by the each segment, wherein said allocating comprises allocating, for a logical qubit of the plurality of logical qubits, a respective cluster ensemble, the cluster ensemble is generated by a segment of the plurality of disjoint segments, the cluster ensemble comprising a set of clusters of physical qubits; and allocating fusion processes to implement the plurality of gate operations, wherein the fusion processes are scheduled to be performed between one or more cluster ensembles representing respective logical qubits, wherein the optimization function is configured to minimize a cost function, wherein the cost function measures a cost of the fusion processes, wherein the cost function measures a first cost for first fusion processes between clusters that are fused over space, wherein the cost function measures a second cost for second fusion processes between clusters that are fused over time, the first cost different from the second cost; and synthesizing the quantum program according to the physical representation, whereby a synthesized quantum program is executable on the measurement-based quantum computer.

Optionally, the cost function is configured to measure at least one of: a quantity of the plurality of quantum sources that are allocated to the plurality of disjoint segments, a number of cycles required for executing the synthesized quantum program on the measurement-based quantum computer, or an error rate of the synthesized quantum program.

Optionally, the logical representation of the quantum program is configured to provide an output via one or more logical output qubits, wherein the error rate of the synthesized quantum program comprises error rates of the one or more logical output qubits.

Optionally, the fusion processes comprise at least one of: fusion gates or unitary gates, wherein the allocation of fusion processes affects the number of cycles.

Optionally, the cost function is configured to measure costs according to a weighting scheme that allocates different weights to different resources.

Optionally, the weighting scheme is obtained from a user.

Optionally, said allocating the one or more logical qubits comprises allocating, for a second logical qubit of the plurality of logical qubits, a second cluster ensemble, wherein said allocating the fusion processes comprises allocating a fusion process between the first and second cluster ensembles.

Optionally, the second cluster ensemble is generated by the segment or by a different segment of the plurality of disjoint segments.

Optionally, the method further comprises determining to dynamically adjust an allocation of resources determined by said converting, whereby the allocation of resources is dynamically adjusted during an execution of the synthesized quantum program, wherein the cost function is configured to measure a cost of said dynamically adjusting.

Optionally, determining the segmentation comprises determining, for each of the plurality of disjoint segments, at least one of: a number of quantum sources allocated thereto, and a dynamic adjustment of the number.

Optionally, said converting comprises allocating fusion processes to implement surface code measurements every defined period.

Optionally, the optimization function defines a Constraint Satisfaction Problem (CSP) that corresponds to the quantum program, the CSP comprises variables, domains and constraints, each variable of the variables has a corresponding domain in the domains that defines one or more potential values of the variable, the constraints define one or more constraints on values of the variables or portion thereof; and the method further comprises generating the synthesized quantum program by utilizing a CSP solver to solve the CSP, wherein a solution of the CSP defines the synthesized quantum program.

Optionally, the logical representation of the quantum program comprises a Directed Acyclic Graph (DAG), wherein nodes of the DAG represent the plurality of gate operations, wherein edges between the nodes represent precedence constraints between the plurality of gate operations, wherein the constraints of the CSP comprise the precedence constraints.

Optionally, the method further comprises executing the synthesized quantum program on the measurement-based quantum computer.

Optionally, the measurement-based quantum computer comprises a photonic quantum computer, and the physical qubits comprise optical qubits.

Another exemplary embodiment of the disclosed subject matter is an apparatus comprising a processor and coupled memory, said processor being adapted to perform: obtaining a logical representation of a quantum program, wherein the logical representation comprises a plurality of logical qubits, wherein the logical representation defines a plurality of gate operations on subsets of the plurality of logical qubits; converting the logical representation to a physical representation of the quantum program that is configured to be executed on a measurement-based quantum computer, wherein said converting is performed according to an optimization function, wherein said converting comprises: determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time; allocating, for each segment of the plurality of disjoint segments, one or more logical qubits of the plurality of logical qubits to be represented by the each segment, wherein said allocating comprises allocating, for a logical qubit of the plurality of logical qubits, a respective cluster ensemble, the cluster ensemble is generated by a segment of the plurality of disjoint segments, the cluster ensemble comprising a set of clusters of physical qubits; and allocating fusion processes to implement the plurality of gate operations, wherein the fusion processes are scheduled to be performed between one or more cluster ensembles representing respective logical qubits, wherein the optimization function is configured to minimize a cost function, wherein the cost function measures a cost of the fusion processes, wherein the cost function measures a first cost for first fusion processes between clusters that are fused over space, wherein the cost function measures a second cost for second fusion processes between clusters that are fused over time, the first cost different from the second cost; and synthesizing the quantum program according to the physical representation, whereby a synthesized quantum program is executable on the measurement-based quantum computer.

Yet another exemplary embodiment of the disclosed subject matter is a computer program product comprising a non-transitory computer readable medium retaining program instructions, which program instructions, when read by a processor, cause the processor to perform: obtaining a logical representation of a quantum program, wherein the logical representation comprises a plurality of logical qubits, wherein the logical representation defines a plurality of gate operations on subsets of the plurality of logical qubits; converting the logical representation to a physical representation of the quantum program that is configured to be executed on a measurement-based quantum computer, wherein said converting is performed according to an optimization function, wherein said converting comprises: determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time; allocating, for each segment of the plurality of disjoint segments, one or more logical qubits of the plurality of logical qubits to be represented by the each segment, wherein said allocating comprises allocating, for a logical qubit of the plurality of logical qubits, a respective cluster ensemble, the cluster ensemble is generated by a segment of the plurality of disjoint segments, the cluster ensemble comprising a set of clusters of physical qubits; and allocating fusion processes to implement the plurality of gate operations, wherein the fusion processes are scheduled to be performed between one or more cluster ensembles representing respective logical qubits, wherein the optimization function is configured to minimize a cost function, wherein the cost function measures a cost of the fusion processes, wherein the cost function measures a first cost for first fusion processes between clusters that are fused over space, wherein the cost function measures a second cost for second fusion processes between clusters that are fused over time, the first cost different from the second cost; and synthesizing the quantum program according to the physical representation, whereby a synthesized quantum program is executable on the measurement-based quantum computer.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1C show exemplary fusions of clusters, in accordance with some exemplary embodiments of the disclosed subject matter;

FIGS. 2A-2B show exemplary applications of gates, in accordance with some exemplary embodiments of the disclosed subject matter;

FIGS. 3A-3B show exemplary applications of gates, in accordance with some exemplary embodiments of the disclosed subject matter;

FIG. 4 shows an exemplary application of quantum gates in the Measurement-Based Quantum Computing (MBQC) framework, in accordance with some exemplary embodiments of the disclosed subject matter;

FIG. 5A shows exemplary error correction in circuit-based quantum computing, in accordance with some exemplary embodiments of the disclosed subject matter;

FIG. 5B shows an exemplary generation of clusters over time, in accordance with some exemplary embodiments of the disclosed subject matter;

FIG. 6 shows an exemplary fusion of clusters over time, in accordance with some exemplary embodiments of the disclosed subject matter;

FIG. 7A shows exemplary layers, in accordance with some exemplary embodiments of the disclosed subject matter;

FIGS. 7B-7D depict exemplary interleaving techniques, in accordance with some exemplary embodiments of the disclosed subject matter;

FIG. 8 shows an exemplary flowchart diagram of a method, in accordance with some exemplary embodiments of the disclosed subject matter; and

FIG. 9 shows an exemplary block diagram of an apparatus, in accordance with some exemplary embodiments of the disclosed subject matter.

### DETAILED DESCRIPTION

One technical problem dealt with by the disclosed subject matter is to implement error correction code for a quantum circuit implemented in a Measurement-Based Quantum Computing (MBQC) scheme. In some exemplary embodiments, quantum error correction may be necessary for quantum computing, e.g., due to the decoherence property of qubits, which causes qubits to lose their quantum properties quickly in the presence of a constant amount of noise per qubit. In some exemplary embodiments, quantum errors may also result from initialization errors, measurement errors, qubit loss, qubit leakage, gate errors, or the like.

In some exemplary embodiments, a qubit's quantum state or property may be described by probability amplitudes. In some cases, errors in the qubit state probability amplitudes may propagate rapidly, if not corrected, causing the qubit state to become unusable. In some exemplary embodiments, in circuit-based quantum computing, one or more quantum error correction codes may be deployed in order to correct quantum state errors, such as stabilizer codes, topological error correction codes, or the like.

In some exemplary embodiments, it may be challenging to implement error correction code within the MBQC framework. In some exemplary embodiments, MBQC may differ from circuit-based quantum computing in many ways. In some exemplary embodiments, in contrast to circuit-based quantum computing, in which a quantum circuit is executed and then measured, in MBQC systems the qubits may be generated and measured every cycle, causing some qubits to collapse (also referred to as to ‘die’) every cycle, and causing the quantum state to be transferred to a next qubit. For example, in case a qubit holds quantum information and collapses due to a measurement, the quantum information may be propagated to an adjacent qubit. In some exemplary embodiments, qubit states may be transferred between generations, from ‘father’ to ‘son’, over the time axis.

In some exemplary embodiments, MBQC systems may utilize one or more types of quantum hardware, qubits, or the like. In some cases, MBQC systems may utilize photon-based qubits, also referred to as optical qubits. For example, MBQC systems may utilize, for its hardware components, optical components such as Linear Optic Quantum Computation (LOQC) components. In optical quantum computing, qubits may be represented by states of photons, such as polarization states or path states. In some exemplary embodiments, photons carrying quantum information may be confined and guided by a physical structure such as a waveguide, which may be designed to direct the propagation of light. For example, optical qubits may comprise quantum data encoded in properties of photons, guided by optical fibers constituting waveguides. In such cases, photons may be manipulated through the waveguides for various quantum computing and communication tasks. In some exemplary embodiments, photons may be generated and propagated over waveguides using one or more generators, such as photonic resource state generators. In other cases, MBQC systems may be implemented in any other way, e.g., without LOQC components. For example, one or more non-optical MBQC systems are disclosed in S. Bartolucci et al. “Fusion-based quantum computation”. arXiv:2101.09310 (2021). arxiv.org/abs/2101.09310, which is hereby incorporated by reference in its entirety for all purposes without giving rise to disavowment. In case of non-optical MBQC systems, the quantum computer may comprise physical qubits that are not optical qubits.

In some exemplary embodiments, employing MBQC systems may offer several advantages over circuit-based quantum computing systems. For example, one advantage may be the ability of MBQC systems to utilize optical qubits or photons. In some exemplary embodiments, despite the requirement for a larger number of optical qubits compared to non-optical qubits, optical qubits can bring significant benefits; they exhibit higher coherence times and necessitate less cooling, among other advantages. For example, high coherence times may be achieved due to LOQC components benefiting from fabrication techniques on silicon chips. In some exemplary embodiments, leveraging LOQC components provides one or more advantages, such as high precision, robustness to environmental noises, low interaction rate with the environment, or the like, which simplify their usage and their integration with other quantum systems and networks.

In some exemplary embodiments, in contrast to circuit-based quantum computing, in which a quantum gate may be executed over qubits, in MBQC systems, applying quantum gates on optical qubits causes the optical qubits to ‘die’ or collapse. In some exemplary embodiments, applying a gate (e.g., a 2-qubit gate or any other gate or measurement) on optical qubits may cause the quantum states of the optical qubits to collapse. In some exemplary embodiments, in order to utilize MBQC systems for implementing a desired functionality, e.g., represented by a quantum program, gate applications within the MBQC framework must be applicable.

In some exemplary embodiments, in order to enable to apply quantum gates on qubits in MBQC systems, without losing the quantum information embedded in the qubits, MBQC systems may employ one or more Fusion-Based Quantum Computation (FBQC) techniques. In some exemplary embodiments, FBQC techniques may enable to fuse, or combine, optical qubits (or any other physical qubits) into clusters. In some exemplary embodiments, FBQC techniques may apply fusion gates on optical qubits, which may combine or fuse the photons using beam splitters and detectors. For example, one or more FBQC techniques are disclosed in S. Bartolucci et al. “Fusion-based quantum computation”. arXiv:2101.09310 (2021). arxiv.org/abs/2101.09310, in U.S. patent application Ser. No. 17/163,219, titled “Fusion based quantum computing”, filed 2021 Jan. 29, in WO Patent Application Number PCT/US2022/054003, titled “Fusion-based quantum repeater”, filed 2022 Dec. 23, and in WO Patent Application Number PCT/US2022/013578, titled “Reconfigurable qubit entangling system”, filed 2022 Jan. 24, which are hereby incorporated by reference in their entirety for all purposes without giving rise to disavowment.

In some exemplary embodiments, the fusion process may involve the interaction of two photons, leading to the detection of one photon and the transfer of its state information to another photon. In some exemplary embodiments, the detection event causes the detected photon to “die”, collapse, or the like, while its state information is transferred to a second photon that participates in the fusion process.

In some exemplary embodiments, the detection event may be seen as an application of a quantum gate and/or operation, such as an application of a measurement operation. In some exemplary embodiments, the detection event may act as a measurement operation that projects the quantum state. For example, a detected photon provides information about the state of the qubits, effectively implementing a measurement quantum operation. As another example, the fusion of photons, which causes a photon to “die” and transfer its state to another photon, can be seen as an application of a quantum gate operation.

In some exemplary embodiments, by performing one or more fusion operations, a cluster of optical qubits to be generated. Such a cluster may comprise optical qubits that are interwoven with one another, collectively representing a same quantum state. In some exemplary embodiments, when two photons (or optical qubits) are fused or entangled by a fusion gate, the qubits that remain after the fusion operations may form a cluster representing a combined quantum state. In some exemplary embodiments, interweaving optical qubits may be performed by fusing a first set of qubits into clusters, fusing two or more clusters together, or the like.

In some exemplary embodiments, FBQC techniques may incorporate several ways of fusing together optical qubits, e.g., using fusion gates such as Bell-State Measurement, using unitary transformations such as two-qubit gates, or the like. In some cases, qubits may be interweaved or fused into a cluster by applying a two-qubit gate of any type on pairs of the qubits. For example, Controlled NOT (CNOT) gates may be applied on pairs of optical qubits to weave them together to form a single cluster. In some exemplary embodiments, optical qubits may be fused to form a cluster by creating entanglement between the qubits. For example, entanglement between the qubits may be created using beam splitters, nonlinear optical processes, measurement-based fusions, by applying gates, or in any other manner.

In some exemplary embodiments, in order to increase a size of a cluster (a qubit-wise size), two or more clusters may be fused together iteratively, until reaching a desired cluster size. For example, pairs of qubits may be fused together to form 2-qubit clusters, two 2-qubit clusters may be fused together to form a larger 3-qubit cluster, two 3-qubit clusters may be fused together to form a larger 5-qubit cluster, and so on.

In some exemplary embodiments, interweaving optical qubits may comprise a probabilistic process that may not necessarily be successful at all attempts. For example, a cluster of interweaved qubits may comprise one or more ‘holes’ in waveguides, representing failed attempts to entangle or weave together qubits that are propagated by the waveguides.

In some exemplary embodiments, clusters of optical qubits generated by FBQC techniques may facilitate the application of quantum gates thereon, without losing quantum information. In some exemplary embodiments, after a cluster is formed, quantum gates may be applied thereto without losing the quantum data of the cluster. For example, applying a 2-qubit gate, a fusion gate, a measurement, or the like, on the cluster may cause at least one of the qubits in the cluster to collapse, while transferring the resulting quantum state (resulting from the gate application) to the remaining qubits of the cluster. In some exemplary embodiments, although the gate application will kill at least one qubit from the cluster, the multitude of qubits in the cluster may ensure that the quantum state represented by the cluster will live on, and will be transferred to the remaining qubits of the cluster, thereby retaining the cluster's quantum state before and after gate applications, without damage.

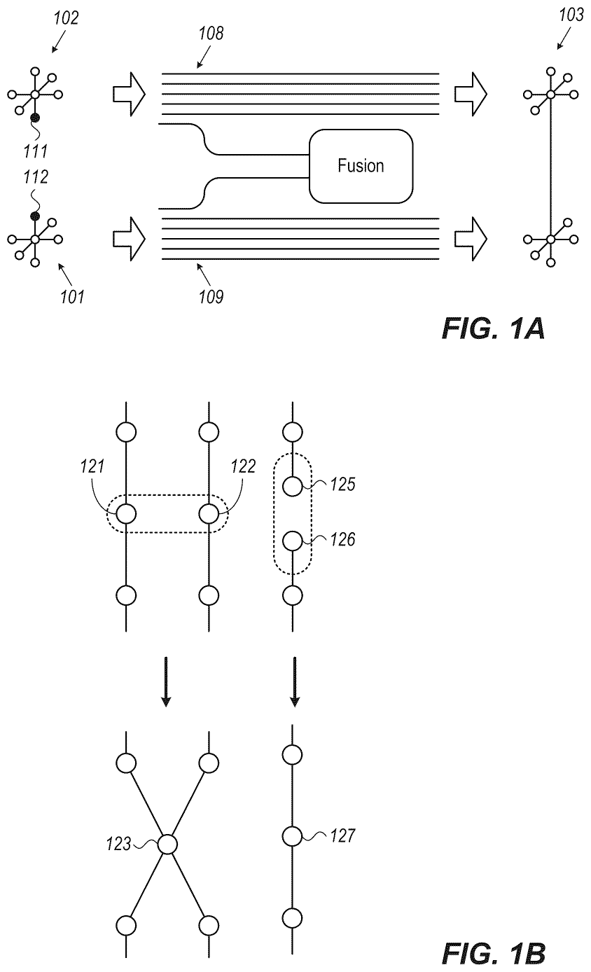

In some exemplary embodiments, the fusion process may cause one or more of the qubits to collapse. For example, fusing two clusters together may cause a respective qubit of each cluster to collapse, e.g., as depicted in FIG. 1A.

Referring now to FIG. 1A, depicting an exemplary fusion of two clusters of optical qubits, in accordance with some exemplary embodiments of the disclosed subject matter. As depicted in FIG. 1A, a first cluster, e.g., Cluster 101, and a second cluster, e.g., Cluster 102, may each comprise seven optical qubits. In some exemplary embodiments, each cluster may be propagated over six respective waveguides, each waveguide routing one or more respective optical qubits, as depicted in FIG. 1A. For example, Cluster 102 may be propagated over Waveguides 108, and Cluster 101 may be propagated over Waveguides 109.

In some exemplary embodiments, in order to fuse together Clusters 101 and 102, Qubit 111 of Cluster 102 may be weld or entwined with Qubit 112 of Cluster 101, e.g., using a fusion gate, a 2-qubit gate, a measurement operation, or the like. In some exemplary embodiments, the fusion process of the clusters may cause Qubits 111 and 112 to collapse, or die, while entangling the remaining qubits of the clusters to a single cluster, e.g., Cluster 103. For example, after fusing Clusters 101 and 102, a single cluster with twelve qubits may remain. In some exemplary embodiments, although Clusters 101 and 102 may constitute 7-qubit clusters, the fusion of the clusters may create Cluster 103 with less than fourteen qubits, e.g., twelve qubits, due to the collapse of Qubits 111 and 112.

In some exemplary embodiments, qubits may be fused or weld over different waveguides, or over a same waveguide. In some cases, fusing qubits over different waveguides may be referred to as a ‘horizontal fusion’, while fusing qubits over a same waveguide (e.g., separated by the time axis) may be referred to as a ‘vertical fusion’. For example, in case Qubits 111 and 112 are propagated over different waveguide, as depicted in FIG. 1A, the fusion of Clusters 101 and 102 may constitute a horizontal fusion.

In some cases, fusing clusters of optical qubits may not necessarily cause qubits of both clusters to collapse. For example, fusing two qubits may cause only one qubit of one of the clusters to collapse, e.g., as depicted in FIG. 1B.

Referring now to FIG. 1B, depicting an exemplary fusion of two clusters, in accordance with some exemplary embodiments of the disclosed subject matter.

As depicted in FIG. 1B, as part of a horizontal fusion process, Qubit 121 of a first cluster that is propagated over a first waveguide may be fused with Qubit 122 of a second cluster that is propagated over a second waveguide, causing the clusters to fuse while killing one of the qubits. For example, one of Qubits 121 and 122 may collapse due to the fusion process, resulting with a fused cluster that includes Qubit 123 as remaining from Qubits 121 and 122. In some exemplary embodiments, the horizontal fusion process may fuse the first and second clusters, which include 3-qubit clusters, into a single 5-qubit cluster, e.g., losing one qubit due to the fusion process. In other cases, any other number of qubits may collapse due to the horizontal fusion process.

As another example, as part of a vertical fusion process, Qubit 125 of a first cluster that is propagated over a waveguide may be fused with Qubit 126 of a second cluster that is propagated over the same waveguide, causing the clusters to fuse while killing one of the qubits. For example, one of Qubits 125 and 126 may collapse due to the fusion process, resulting with a fused cluster that includes Qubit 127 as remaining from Qubits 125 and 126. The resulting qubit, Qubit 127, may be propagated over the same waveguide. In some exemplary embodiments, the vertical fusion process may fuse the first and second clusters, which include 2-qubit clusters, into a single 3-qubit cluster, e.g., losing one qubit due to the fusion process. In other cases, any other number of qubits may collapse due to the vertical fusion process.

Referring now to FIG. 1C, depicting an exemplary fusion of four clusters, in accordance with some exemplary embodiments of the disclosed subject matter.

In some exemplary embodiments, FIG. 1C depicts four clusters, e.g., Clusters 131-134. As depicted in FIG. 1C, fusing processes may be performed between Clusters 131-134. In some exemplary embodiments, Clusters 131 and 134 may be fused, by welding Qubit 142 of Cluster 134 with Qubit 141 of Cluster 131, resulting with both Qubits 141 and 142 collapsing. In some exemplary embodiments, Clusters 131 and 132 may be fused, by welding Qubit 143 of Cluster 131 with Qubit 144 of Cluster 132, resulting with both Qubits 143 and 144 collapsing. In some exemplary embodiments, Clusters 132 and 133 may be fused, by welding Qubit 145 of Cluster 132 with Qubit 146 of Cluster 133, resulting with both Qubits 145 and 146 collapsing. In some exemplary embodiments, Clusters 133 and 134 may be fused, by welding Qubit 147 of Cluster 133 with Qubit 148 of Cluster 134, resulting with both Qubits 147 and 148 collapsing. In other cases, instead of two qubits collapsing for every welding operation of two respective clusters, a single qubit may collapse, e.g., similarly to FIG. 1B.

In some exemplary embodiments, after fusing together Clusters 131-134 to a single entangled cluster, Cluster 150 may be formed. In some exemplary embodiments, Cluster 150 may comprise a cluster of the optical qubits of Clusters 131-134, without the qubits that collapsed during the fusion process, e.g., without Qubits 141-148. For example, four qubits may remain after the collapse of Qubits 141-148, resulting with the 4-qubit cluster represented by Cluster 150.

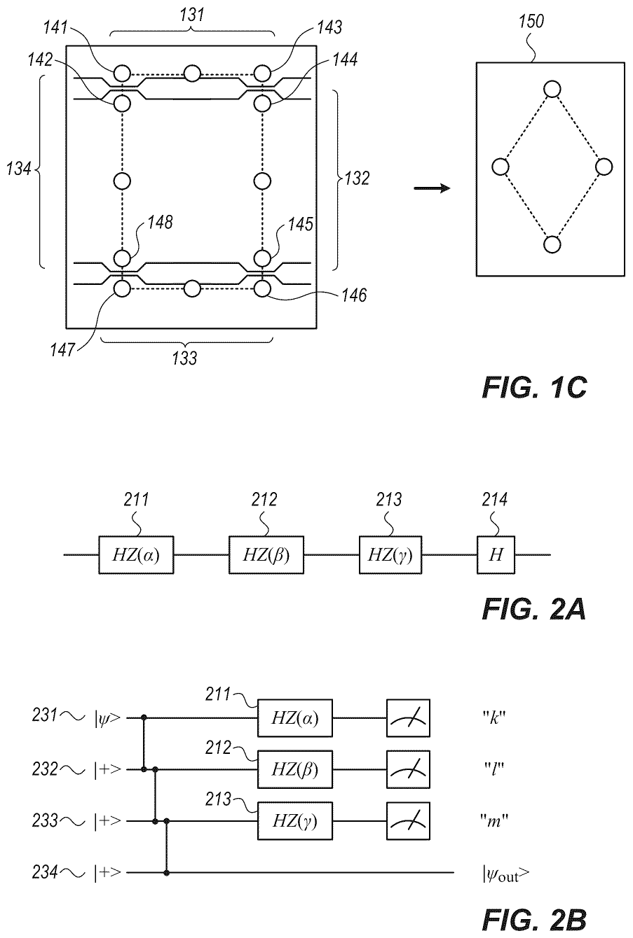

In some exemplary embodiments, after a cluster of a desired size is formed, quantum gates may be applied thereto without losing the quantum data of the cluster. In some exemplary embodiments, a generated cluster may be manipulated by one or more measurements, gates, or the like, e.g., according to FIG. 2A.

Referring now to FIGS. 2A-2B, depicting exemplary applications of gates, in accordance with some exemplary embodiments of the disclosed subject matter.

In some exemplary embodiments, after a cluster of a desired size is formed, one or more quantum gates may be applied thereto. For example, in case the cluster represents a logical qubit of a quantum circuit, and the quantum circuit instructs to apply quantum gates on the state of the qubit, it may be desired to apply the quantum gates on the cluster. In some cases, it may be desired to apply to the cluster universal quantum gates such as Pauli-X gates, Pauli-Y gates, Pauli-Z gates, Hadamard gates, or the like. For example, it may be desired to rotate a quantum state in three angles: α, β, and γ, using three 1-qubit rotation gates.

As depicted in FIG. 2A, in circuit-based quantum computing, the quantum state may be held by a single qubit or qubit register, and three rotation gates may be applied on the qubit to rotate its state. For example, Gates 211, 212, and 213 may comprise respective rotation gates that are applied on the same non-optical qubit, to obtain a desired manipulation of the quantum state. In some exemplary embodiments, the manipulated version of the quantum state may be referred to as the target state. In some exemplary cases, the scenario of FIG. 2A may incorporate an additional Hadamard gate, Gate 214, in addition to Gates 211, 212, and 213.

In some exemplary embodiments, the application of Gates 211, 212, and 213 on the qubit in circuit-based quantum computing, according to the scenario of FIG. 2A, may be represented by the following equation:

$$R ( θ ) = Z ( γ ) X ( β ) Z ( α ) = HHZ ( γ ) HX ( β ) HZ ( α ) \qquad ( 1 )$$

wherein θ represents the original quantum state of the qubit before the manipulation, α, β, and γ represent the respective angles in which the state is intended to be rotated, and H, X, and Z represent quantum gates. For example, X may represent an XNOT gate (e.g., a Pauli-X gate), Z may represent a Pauli-Z gate, and H may represent a Hadamard gate.

In some exemplary embodiments, when utilizing the MBQC framework, the same operation of applying three rotation gates may be performed differently, e.g., due to the collapsing property of optical qubits, causing them to collapse upon gate applications. As depicted in FIG. 2B, in order to mitigate the collapsing property, the quantum state may be held by a cluster of at least four optical qubits. In some exemplary embodiments, the cluster may comprise Qubits 231, 232, 233, and 234.

In some exemplary embodiments, the quantum state held by the cluster of qubits may be manipulated by applying the three rotation gates thereon. In some exemplary embodiments, Gate 211 may be applied to the cluster, causing Qubit 231 of the cluster to collapse, and the quantum state may be transferred from Qubit 231 to an adjacent qubit, e.g., Qubit 232. In some exemplary embodiments, Gate 212 may be applied to the cluster, causing Qubit 232 to collapse, and the resulting quantum state may be transferred from Qubit 232 to an adjacent qubit, e.g., Qubit 233. In some exemplary embodiments, Gate 213 may be applied to the cluster, causing Qubit 233 to collapse, and the resulting quantum state may be transferred from Qubit 233 to Qubit 234. In some exemplary embodiments, at the end of the gate applications, Qubit 234 may hold a manipulated version of the original quantum state of Qubit 231, after Gates 211, 212, and 213 are applied thereto.

In some exemplary embodiments, the application of Gates 211, 212, and 213 on the quantum state of the cluster, according to the scenario of FIG. 2B, may be represented by the following equation:

$$\vert {ψ}_{out} 〉 = ( {X}^{m} HZ ( γ ) ) ( {X}^{l} HZ ( β ) ) ( {X}^{k} HZ ( α ) ) \vert ψ 〉 \qquad ( 2 )$$

wherein ψ represents the original quantum state held by Qubit 231, α, β, and γ represent the angles in which the state is intended to be rotated by the three gates, m, l, and k represent statistical deviations of the measurements, H, X, and Z represent quantum gates, and ψₒᵤₜ represents a resulting quantum state of Qubit 234 (resulting from the manipulation of the original quantum state of Qubit 231).

In some exemplary embodiments, the scenarios of FIGS. 2A and 2B may be interchangeable with respect to their effect, at least since after applying Gates 211, 212, and 213 in the scenario of FIG. 2B, Qubit 234 may hold the same target state as the state held by the non-optical qubit of FIG. 2A after the applications of the gates. In some exemplary embodiments, the scenario of FIG. 2B may differ from the scenario of FIG. 2A in one or more manner, at least since the gates in FIG. 2B exclude Gate 214 (a Hadamard (H) gate). In some cases, Gate 214 may be redundant in the MBQC framework due to the pre-processing stage of fusing together Qubits 231, 232, 233, and 234 into a cluster, which may be equivalent to applying the Hadamard (H) gate.

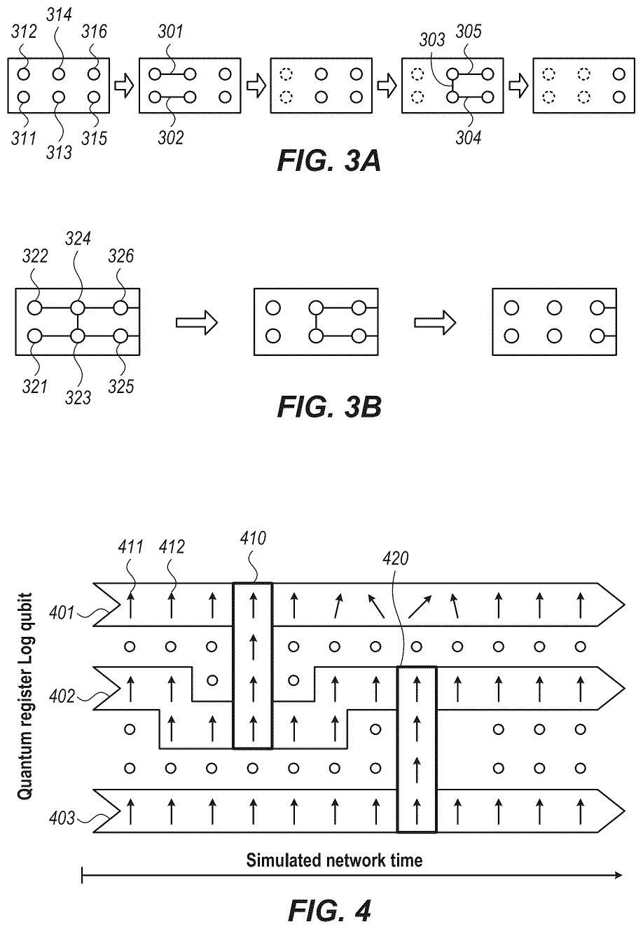

In some exemplary embodiments, other quantum gates may be similarly implementable in the MBQC framework. For example, applications of 1-qubit gates in the circuit-based quantum computing may be convertible to applications of 1-qubit gates over a cluster of optical qubits in the MBQC framework, similarly to FIGS. 2A-2B. In some exemplary embodiments, any other quantum gate implementations may be converted from the circuit-based quantum computing framework to the MBQC framework. In some cases, it may be desired to apply 2-qubit gates, or any other multi-qubit gates, to a cluster in the MBQC framework, without losing the quantum data of the cluster. For example, quantum gates that are applicable to more than one qubit, such as 2-qubit gates, may be implementable in the MBQC framework without losing the quantum data of the cluster, e.g., as depicted in FIG. 3B.

Referring now to FIGS. 3A-3B, depicting exemplary applications of gates, in accordance with some exemplary embodiments of the disclosed subject matter.

In some exemplary embodiments, the MBQC framework may enable to implement universal gates and operations, including 2-qubit gates, e.g., as depicted in FIGS. 3A-3B. For example, the MBQC framework may enable to apply a 2-qubit gate such as a Controlled-Z (CZ) gate over two qubits, similarly to that of the circuit-based framework.

As depicted in FIG. 3A, in the circuit-based quantum computing framework, a circuit may comprise a set of non-optical qubits including Qubits 311-316. It may be desired to obtain a target state from applying a 2-qubit CZ gate between the top row of qubits (Qubits 311, 313, and 315), and between the bottom row of qubits (Qubits 312, 314, and 316). For example, Qubits 311 and 312 may hold respective quantum states, and the remaining qubits may not hold a specified quantum state, may be initialized to ground state, or the like.

In some exemplary embodiments, CZ Gate 302 may be applied between Qubits 311 and 313, and CZ Gate 301 may be applied between Qubits 312 and 314, thereby transferring the quantum states of Qubits 311 and 312 to Qubits 313 and 314, respectively. In some exemplary embodiments, Qubits 311 and 312 may be measured, thereby collapsing their quantum state (not the qubit itself, in contrast to the MBQC framework), without harming the quantum states that are held by Qubits 313 and 314.

In some exemplary embodiments, CZ Gate 303 may be applied to Qubits 313 and 314, thereby applying the CZ gate between the two rows of qubits. In some exemplary embodiments, in order to measure the resulting state without causing the calculated state to collapse, CZ Gate 304 may be applied between Qubits 313 and 315, and CZ Gate 305 may be applied between Qubits 314 and 316, thereby transferring the resulting state to Qubits 315 and 316. In some exemplary embodiments, Qubits 313 and 314 may be measured, thereby measuring the outcome of the CZ gate between the two rows of qubits. In some exemplary embodiments, the measurement of Qubits 313 and 314 may cause the states held by Qubits 313 and 314 to collapse, while preserving the quantum state at Qubits 315 and 316.

In some exemplary embodiments, when utilizing the MBQC framework, the same operation of applying a CZ gate on first and second quantum states may be implemented differently. For example, as depicted in FIG. 3B, in order to implement the CZ gate application in the MBQC framework, a cluster of optical qubits may be initially formed, e.g., by applying CZ gates between all optical qubits in the cluster, or in any other manner. In some exemplary embodiments, the cluster may comprise Qubits 321-326, which may comprise interweaved optical qubits.

In some exemplary embodiments, the same target state obtained in FIG. 3A may be obtained in the MBQC framework, by measuring states of the cluster. For example, instead of applying CZ gates to the cluster, the cluster qubits may be measured, thereby causing the qubits to collapse and their states to be transferred to an output qubit. Since the formation of the cluster is based on application of CZ gates, the transferred resulting state may correspond to the target state (e.g., although measurements are applied as opposed to CZ gates).

In some exemplary embodiments, the target state may be obtained by measuring the states of Qubits 321 and 322 (e.g., using a CZ gate or any other gate), thereby causing Qubits 321 and 322 to collapse and causing their quantum states to be transferred to Qubits 323 and 324. In some exemplary embodiments, subsequently, the states of Qubits 323 and 324 may be measured, thereby causing Qubits 323 and 324 to collapse and causing their quantum states to be transferred to Qubits 325 and 326. In some exemplary embodiments, a CZ gate may be applied to Qubits 325 and 326, thereby causing one of Qubits 325 and 326 to collapse, and the other to hold the target state (e.g., the same target state from the scenario of FIG. 3A). In some exemplary embodiments, in the scenario of FIG. 3B, the output qubit (Qubit 325 or 326) may hold the same target state as the target state in FIG. 3A.

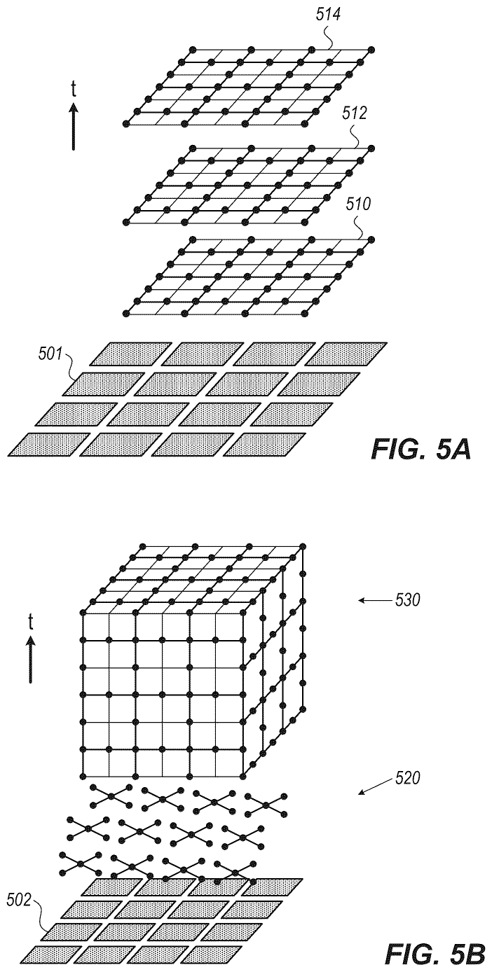

In some exemplary embodiments, any other application of any other quantum gates in circuit-based quantum computing may be similarly implementable and/or converted to the MBQC framework, e.g., as depicted in FIG. 4. For example, applications of universal gates in the circuit-based quantum computing may be converted to measurements of a cluster of optical qubits in the MBQC framework.

Referring now to FIG. 4, depicting exemplary application of quantum gates in the MBQC framework, in accordance with some exemplary embodiments of the disclosed subject matter.

In some exemplary embodiments, FIG. 4 depicts three clusters of optical qubits: Clusters 401, 402, and 403. In other cases, any other number of clusters may be formed, each having any other number of optical qubits. In some exemplary embodiments, qubits within each cluster may comprise fused qubits, entangled qubits, or the like. For example, qubits within each of Clusters 401, 402, and 403 may be entangled, may represent a same quantum state, or the like. In some exemplary embodiments, Clusters 401, 402, and 403 may be fused together, or entangled, via quantum operations such as gates. For example, Gate 410 may fuse Clusters 401 and 402 together, and Gate 420 may fuse Clusters 402 and 403 together, thereby entangling all the clusters to one large cluster.

In some exemplary embodiments, after Clusters 401, 402, and 403 are formed, quantum gates may be applied thereto, thereby manipulating the states of the clusters without losing their quantum state. In some exemplary embodiments, the number of quantum gates that may be applicable to a cluster without collapsing the cluster's state may depend on the number of qubits in the cluster. For example, the number of quantum gates that may be applicable to a cluster without collapsing its state may be smaller than the number of qubits in the cluster. In some cases, in case a cluster comprises N qubits, the number of quantum gates that may be applicable to the cluster without collapsing the cluster may be N−1.

In some exemplary embodiments, applying a gate on a qubit of a cluster may cause the qubit to collapse, and may cause the resulting quantum state (resulting from applying the gate) to be transferred the remaining qubits of the cluster, to an adjacent qubit in the cluster, or the like. For example, applying a 1-qubit gate such as a measurement operation over Qubit 411 within Cluster 401 may cause Qubit 411 to collapse, while transmitting the result of the measurement operation to another qubit of Cluster 401, e.g., Qubit 412. In some exemplary embodiments, although applying a gate on a cluster will kill at least one qubit from the cluster, the multitude of qubits in the cluster may ensure that the quantum state represented by the clusters' qubits will live on and be transferred to the remaining qubits, thereby retaining the quantum states and enabling to apply gates thereto without damage.

The disclosed subject matter is configured to address the technical problem of how to implement error correction code for a quantum circuit in a MBQC scheme. It may be desired to implement one or more types of error correction schemes within the MBQC framework, which may involve implementing universal gates within the MBQC framework. For example, it may be desired to ensure that an error rate of a target state complies with a threshold, falls within an acceptable range or error rates, or the like.

Another technical problem dealt with by the disclosed subject matter is implementing a topological error correction scheme such as surface code in the MBQC framework.

In some exemplary embodiments, in circuit-based quantum computing, one or more quantum error correction codes and schemes may be deployed in order to correct quantum state errors, such as stabilizer codes, topological error correction codes, or the like. For example, topological error correction codes may comprise a surface code technique. In some cases, quantum error correcting code may be implemented in circuit-based quantum computing, by a quantum execution platform (e.g., a quantum computer) in order to spread information of at least one logical qubit onto a highly entangled state of several physical qubits. In some exemplary embodiments, this may enable to store the information of the logical qubit onto a highly entangled state of the physical qubits. For example, a topological error correction scheme, such as surface code or color code, may achieve quantum error correction by spreading information of one or more logical qubits of a quantum program onto a set of physical qubits of the quantum execution platform. As an example, surface code may comprise an error correction scheme in which logical qubits are represented by respective sets of physical qubits, while enabling operations between the logical qubits, as disclosed, for example, in Fowler et al. “Surface codes: Towards practical large-scale quantum computation” Phys. Rev. A 86, 032324 (18 Sep. 2012), which is hereby incorporated by reference in its entirety for all purposes without giving rise to disavowment. In some exemplary embodiments, syndrome measurements may be used to determine whether a qubit state has been corrupted, enabling the correction of such errors. In some exemplary embodiments, surface code techniques may be optimized in one or more manners, such as disclosed in U.S. Pat. No. 11,416,762 B1, titled “Selecting Physical Qubits For Quantum Error Correction Schemes”, filed Apr. 14, 2022, U.S. patent application Ser. No. 18/444,281, titled “Topological Error Correction”, filed Feb. 16, 2024, and U.S. Pat. No. 11,615,337 B1, titled “Determining Quantum Error Correction Schemes”, filed Apr. 18, 2022, which are hereby incorporated by reference in their entirety for all purposes without giving rise to disavowment.

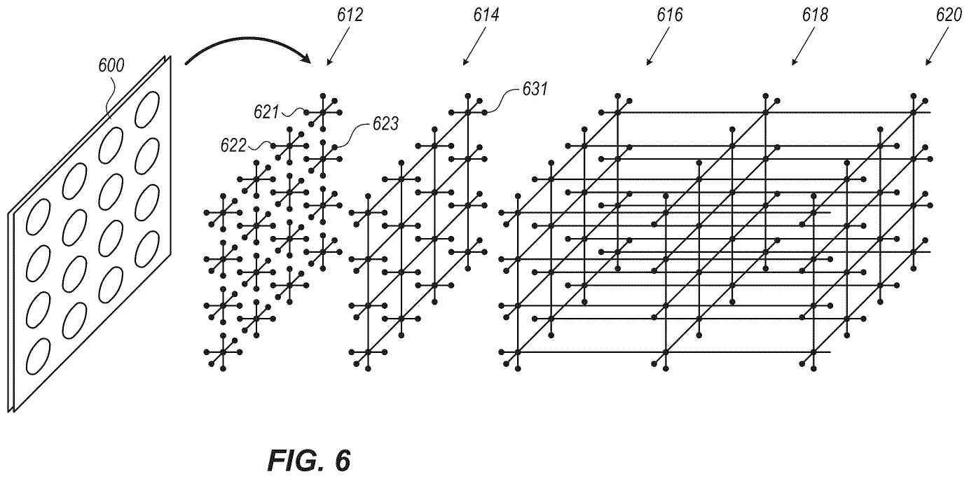

In some exemplary embodiments, within the realm of circuit-based quantum computing, a topological error correction scheme such as surface code may utilize one or more operations in order to control or manage the error rate of an executed circuit. In some exemplary embodiments, in addition to spreading information of logical qubits onto a set of physical qubits, surface code may be characterized by periodical measurements of a first subset of physical qubits, which may be performed by a second subset of physical qubits that are directly connected or wired to the first subset. In some exemplary embodiments, a quantum state of a logical qubit represented by a plurality of physical qubits may remain stable (error-wise) due to the periodic measurements. For example, measurements may be performed every defined timeframe, e.g., as depicted in FIG. 5A.

In some exemplary embodiments, it may be desired to implement the surface code technique, including the collective representation of quantum states of logical qubits and the periodic measurements, within the MBQC framework.

Referring now to FIG. 5A, depicting exemplary error correction in circuit-based quantum computing, in accordance with some exemplary embodiments of the disclosed subject matter.

In some exemplary embodiments, topological error correction codes, such as surface code, may constitute a class of quantum error correction codes that relies on the topology of a two-dimensional lattice, a plane, a connectivity graph, an array, or a surface (referred to hereinafter as “lattice”). In some exemplary embodiments, in circuit-based quantum computing, the lattice defines the connectivity of the physical qubits. For example, Lattice 501 may comprise an array of matter-based qubits with defined connectivity settings between each two physical qubits.

In some exemplary embodiments, when implementing error correction code, such as surface code, in circuit-based quantum computing, the entire Lattice 501, or portions thereof, may be used to represent one or more logical qubits and to apply thereon quantum operations as defined by a respective quantum program. For example, a quantum program may be provided by a user, and implemented on a quantum execution platform according to one or more compilers, transpilers, or the like.

In some exemplary embodiments, surface code architectures may be employed to periodically correct qubits, over the time axis. For example, a first subset of qubits in Lattice 501 (‘measuring’ qubits) may be configured to periodically measure and correct attached qubits belonging to a second subset of qubits (′measured qubits), if they are directly connected or wired thereto. In some exemplary embodiments, within the settings of Lattice 501, measurement interactions between qubits may be limited to their nearest neighbors. In some exemplary embodiments, by employing the surface code architecture in circuit-based quantum computing, a quantum state of a logical qubit represented by Lattice 501 or portion thereof may remain stable (error-wise) due to the periodic measurements.

In some exemplary embodiments, measurements of a second subset of qubits in Lattice 501 may be periodically performed by the first subset of qubits in Lattice 501. In some exemplary embodiments, the first and second subsets may be disjoint, and all qubits in Lattice 501 may be included in either the first or second subset. In some exemplary embodiments, measurements of the second subset of qubits may be performed over the time axis, periodically.

For example, at a first point along the time axis, Lattice 501 may execute Error Correction 510 by measuring and correcting the second subset of qubits. It is noted that the second subset of qubits are denoted in FIG. 5A as black dots within Error Correction 510, while the first subset of qubits may not be explicitly depicted. Error Correction 510 may encompass the first subset of ‘measuring’ qubits performing measurements and corrections on their closest neighboring qubits (e.g., the second subset of qubits directly wired to each ‘measuring’ qubit). In some exemplary embodiments, at a second subsequent point along the time axis, Lattice 501 may conduct Error Correction 512, which involves the same group of ‘measuring’ qubits measuring and correcting their nearest neighbor qubits after a defined time interval has elapsed since Error Correction 510. At a third point along the time axis, Lattice 501 may execute Error Correction 514, corresponding to Error Corrections 510 and 512, by measuring and correcting qubits after the defined time interval has elapsed since Error Correction 512.

In some exemplary embodiments, the lattice grid may be partitioned into a plurality of units used to host respective “patches” of the lattice, e.g., for representing logical qubits, auxiliary regions for performing operations between logical qubits, or the like. For example, each patch may collectively represent one or more quantum states of respective logical qubits. In some cases, such patches may correspond at least in part to the patches disclosed in D. Litinski. “A Game of Surface Codes: Large-Scale Quantum Computing with Lattice Surgery”. arXiv:1808.02892 (2018). arxiv.org/abs/1808.02892, which is hereby incorporated by reference in its entirety for all purposes without giving rise to disavowment. In some exemplary embodiments, operations that are defined in a user's quantum program between two logical qubits, may be implemented between patches of the lattice that represent the two logical qubits.

In some exemplary embodiments, quantum programs may be obtained and executed on Lattice 501 over the time axis, while the Lattice 501 remains static and unchanged. For example, a two-dimensional surface of Lattice 501 may remain static, as well as the division of qubits within Lattice 501 to ‘measuring’ qubits and measured qubits, while different quantum programs may be implemented thereon by dynamically allocating areas of Lattice 501 to different patches, dynamically allocating areas of Lattice 501 to auxiliary regions between the patches, and ordering gate operations between the patches of Lattice 501, or the like.

In some exemplary embodiments, instead of the circuit-based implementation of surface code, it may be desired to implement a surface code scheme in the MBQC framework. For example, it may be desired to represent, within the MBQC framework, quantum states of logical qubits collectively, and perform periodic measurements to stabilize the collectively represented states.

Yet another technical problem dealt with by the disclosed subject matter is implementing an error correction scheme such as surface code in the MBQC framework according to an optimization function.

Yet another technical problem dealt with by the disclosed subject matter is implementing an error correction scheme such as surface code in the MBQC framework according to an optimization function that takes into account the possibility of dynamically adjusting resource allocations during a program execution.

One technical solution provided by the disclosed subject matter may comprise implementing a quantum program in the MBQC framework using an error correction scheme such as surface code, by utilizing clusters of qubits as collective state representations, and using fusion operations (e.g., gates or measurements) as periodic measurements. In some exemplary embodiments, an optimization function may be used determine an implementation of the quantum program in which clusters of optical qubits are allocated for representing a quantum state of each logical qubit, and fusion operations are scheduled between such clusters for representing the periodic measurements of the surface code.

In some cases, the optimization function may be customized by a user, to represent the user's desired balance or tradeoff between different quantum resources, between desired error rates, or the like. In some cases, the optimization function may be static, obtained from a third-party, obtained from another entity besides the user, or the like. In some cases, the tradeoff between quantum resources may correspond at least in part to the tradeoff disclosed in U.S. patent application Ser. No. 18/317,025, titled “Time-bin qubit converter”, filed 2023 May 12, which is hereby incorporated by reference in its entirety for all purposes without giving rise to disavowment.

In some exemplary embodiments, instead of utilizing a matter-based lattice such as Lattice 501 of FIG. 5A, the surface code scheme may be implemented over a photonic-based lattice. In some exemplary embodiments, a photonic-based lattice may comprise a lattice of photonic resource state generators, which may comprise generators configured to generate photonic qubits, clusters of photonic qubits, or the like. In some exemplary embodiments, photonic resource state generators, also referred to as “quantum sources”, “quantum emitters”, “resource-state generators” or “light sources”, may be responsible for generating individual or entangled photons with quantum information that serve as qubits in quantum information processing tasks.

In some exemplary embodiments, quantum sources may be configured to generate the photons, or optical qubits, periodically. For example, as depicted in FIG. 5B, segments of quantum sources may periodically generate layers of clusters of photons. In some exemplary embodiments, a ‘layer’ may refer to a set of optical qubits (e.g., clusters, individual qubits, or the like) that are generated by a lattice of quantum sources at a same time, that have a same timestamp, or the like. Layers may or may not be entangled. For example, every period of 1 millisecond, 1 microsecond, or the like, each quantum source may produce a photon associated with the respective timestamp. As another example, every period of 1 millisecond, 1 microsecond, or the like, each segment of quantum sources may produce a cluster of photons associated with the respective timestamp.

In some exemplary embodiments, the optimization function may allocate or bin the quantum sources to segments. In some exemplary embodiments, the lattice of quantum sources may be allocated, divided, or the like, into different segments. In some exemplary embodiments, the segments may be disjoint, and all quantum sources in the lattice may be included in one of the segments. For example, a segment of quantum sources may periodically create a cluster with a respective number of photons (e.g., one for each quantum source in the segment), within respective waveguides. As another example, a segment of quantum sources may periodically create more than one cluster within their waveguides.

In some exemplary embodiments, the optimization function may allocate the logical qubits of the quantum program to respective cluster ensembles. In some exemplary embodiments, quantum states of logical qubits may be represented by cluster ensembles, which may comprise one or more clusters or individual qubits that are generated by a single segment of quantum sources. For example, a cluster ensemble may comprise a single cluster, a plurality of clusters within a single layer generated by the respective segment, an entire layer generated by the respective segment, clusters of different layers generated by the respective segment, a plurality of layers generated by the respective segment, portions of the plurality of layers, or the like.

In some exemplary embodiments, the optimization function may allocate one or more cluster ensembles for each segment of the lattice. For example, a segment may be used to represent a single cluster ensemble, two cluster ensembles, three cluster ensembles, or the like. It is noted that the number of cluster ensembles allocated to different segments may differ, and may not be uniform. For example, a first segment may be allocated a single cluster ensemble to represent a logical state of a first logical qubit by all of the generated layers of the first segment, while a second segment may be allocated four cluster ensembles to represent the logical states of second, third, fourth, and fifth logical qubits. According to this example, the four cluster ensembles of the second segment may each comprise a full layer, a portion of a layer, a portion of a plurality of layers, or the like, and may or may not be uniform.

In some exemplary embodiments, the periodical measurements of the surface code scheme may be implemented in the MBQC framework, by using fusion processes such as measurements and gate applications as stabilizer measurement required for error detection and correction. In some exemplary embodiments, the MBQC framework may be used to perform the necessary periodic stabilizer measurements for the surface code, leveraging fusion processes and gate applications for identifying and correcting errors. For example, a detection event of a photon that occurs during a fusion process and causes the photon to collapse, may at the same time serve as a stabilizer measurement, providing information necessary for error correction.

In some exemplary embodiments, the optimization function may allocate one or more logical gates and/or measurements to be performed between the logical qubits. In some exemplary embodiments, the logical gates may be implemented between cluster ensembles that represent the logical qubits, and may be implemented by a fusion process. For example, cluster ensembles may be fused or weld together between different waveguides, within a single waveguide, or the like, in order to implement a logical gate.

Referring now to FIG. 5B, depicting an exemplary generation of photon clusters over time, in accordance with some exemplary embodiments of the disclosed subject matter.

In some exemplary embodiments, instead of utilizing a matter-based lattice such as Lattice 501, a photonic-based lattice of quantum sources may be utilized, e.g., Lattice 502. In some exemplary embodiments, Lattice 502 may comprise photonic resource state generators, or quantum sources, which may periodically generate a set of photonic qubit clusters, e.g., Clusters 520 in one or more layers. In some exemplary embodiments, in order to create Clusters 520, the quantum sources may fuse or weld together qubits of one or more waveguides. For example, Clusters 520 may be created by appliance of fusion gates, measurements, unitary gates, or the like.

For example, the quantum sources may generate, every defined time period, a layer of 4×4 clusters in which each cluster comprises seven optical qubits (e.g., together constituting a single ‘layer’). In other cases, the quantum sources may generate layers of any other number of clusters, and each cluster may comprise any other numbers of optical qubits, single optical qubits, or the like. In some cases, layers generated by Lattice 502 may comprise one of more holes. For example, the 4×4 layer may comprise one or more clusters with holes, or missing qubits, in the waveguides, representing failed attempts to entangle or weave together qubits.

In some exemplary embodiments, after initial clusters such as Clusters 520 are created by the quantum sources, one or more subsequent fusion operations (fusion gates, measurements, unitary gates, or the like) may be applied on the generated clusters. In some exemplary embodiments, as time elapses, clusters within layers may be fused with other clusters of the same layer, as well as with clusters of adjacent layers. For example, Cube 530 may comprise a three-dimensional (3D) cube of optical qubits clusters that are fused in time and space.

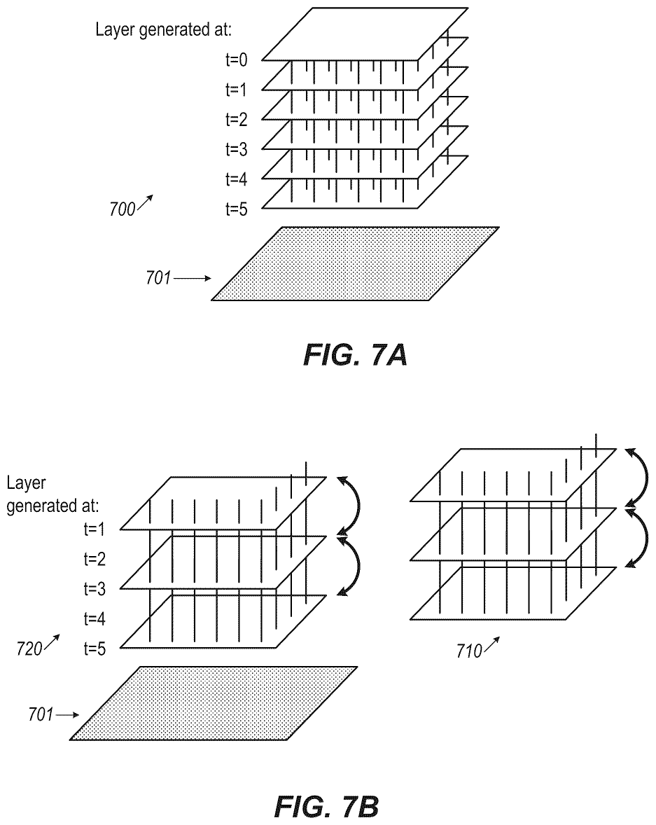

In some exemplary embodiments, clusters may be fused with other clusters of a same layer, with clusters of neighboring layers, or the like, e.g., in order to create Cube 530. For example, FIG. 6 depicts an exemplary fusion of clusters over time and space. In some exemplary embodiments, layers created by Lattice 502 at different times may co-exist within the same waveguides, resulting with a plurality of layers over space and over the time axis. For example, a single waveguide may comprise an optical qubit that belongs to a cluster of a first layer, and a second optical qubit that belongs to a cluster of a second subsequent layer. In some exemplary embodiments, the fusion of clusters may correspond to the necessary periodic stabilizer measurements that implement surface code.

Referring now to FIG. 6, depicting an exemplary fusion of clusters over time, in accordance with some exemplary embodiments of the disclosed subject matter.

In some exemplary embodiments, a set of quantum sources such as Quantum Sources 600 may generate layers of clusters, e.g., Layers 612, 614, 616, 618, and 620. In some exemplary embodiments, each layer may be generated along a different point on the time axis, consecutively. For example, Layers 612, 614, 616, 618, and 620 may constitute successive layers of clusters generated at consecutive times of the time axis.

In some exemplary embodiments, Quantum Sources 600 may depict a plurality of quantum sources for generating clusters of optical qubits. For example, Quantum Sources 600 may generate clusters of seven optical qubits each, as depicted in Layer 612 of FIG. 6. In some exemplary embodiments, Quantum Sources 600 may employ one or more Fusion-Based Quantum Computation (FBQC) techniques for generating the clusters.

In some exemplary embodiments, after clusters are generated by Quantum Sources 600 and propagated via waveguides, a fusion process may be performed between generated clusters. For example, Layer 614 may comprise a layer of clusters corresponding to Layer 612, after the clusters within Layer 614 are fused with each other over space. In some exemplary embodiments, clusters within Layer 614 may be fused with their neighboring clusters that also belong to Layer 614, causing some qubits of each cluster to collapse, resulting with Layer 614 having less qubits overall than Layer 612. For example, Cluster 621 within Layer 612 may be fused with its neighbor clusters, e.g., Clusters 622 and 623 in the same layer. According to this example, the fusion may cause two qubits of the seven-qubit clusters (Clusters 621, 622 and 623) to collapse, resulting with the corresponding clusters in Layer 614 having only five qubits. For example, one qubit of Cluster 621 may die due to the fusion with Cluster 622, and a second qubit of Cluster 621 may die due to the fusion with Cluster 623, resulting with Cluster 631 of Layer 614.

In some exemplary embodiments, fusions between clusters of a same layer (and timestamp) may be referred to as a ‘fusion over space’ or ‘horizontal fusion’, and may utilize a different amount of resources compared to other types of fusions (e.g., compared to temporal fusions).

In some exemplary embodiments, a fusion over time may be performed between different layers of clusters that are generated by Quantum Sources 600. In some cases, Layer 616 may comprise a layer of clusters corresponding to Layer 614, after being fused over the time axis with the consecutive layer. For example, every period of 1 millisecond, microsecond, or the like, Quantum Sources 600 may produce a layer of clusters associated with a respective timestamp, and clusters of successive layers may be fused temporally over the same waveguides. In some exemplary embodiments, during a temporal fusion, one or more fusion processes may be applied to clusters of different layers and timestamps, causing them to be fused with one another. For example, clusters originating from the same quantum source at different timestamps, may be included in different layers and may be fused with one another over the time axis (e.g., as a vertical fusion).

In some exemplary embodiments, fusions between clusters of different layers (and different timestamps) may be referred to as a ‘fusion over time’, or a ‘temporal fusion’. It is noted that a fusion over time may not necessarily comprise vertical fusion, as they may be performed by fusing qubits over same or different waveguides. In some cases, a temporal fusion may comprise temporal multiplexing that uses different time slots to encode and transmit multiple quantum signals over the same physical channel, while a fusion over space may comprise spatial multiplexing that uses different physical channel to encode and transmit respective quantum signals.

As depicted in FIG. 6, clusters of Layers 616, 618, and 620 may be fused over time. In some exemplary embodiments, the temporal fusion may cause at least some of the qubits of Layers 616 and 618 to collapse, while leaving at least one qubit in each cluster that retains the quantum state.

In some exemplary embodiments, in order to implement a quantum program using surface code, each logical qubit of the quantum program may be represented by one or more clusters of Layers 612-620, and the periodic stabilizer measurements of the surface code may be implemented by fusions over time and/or space.

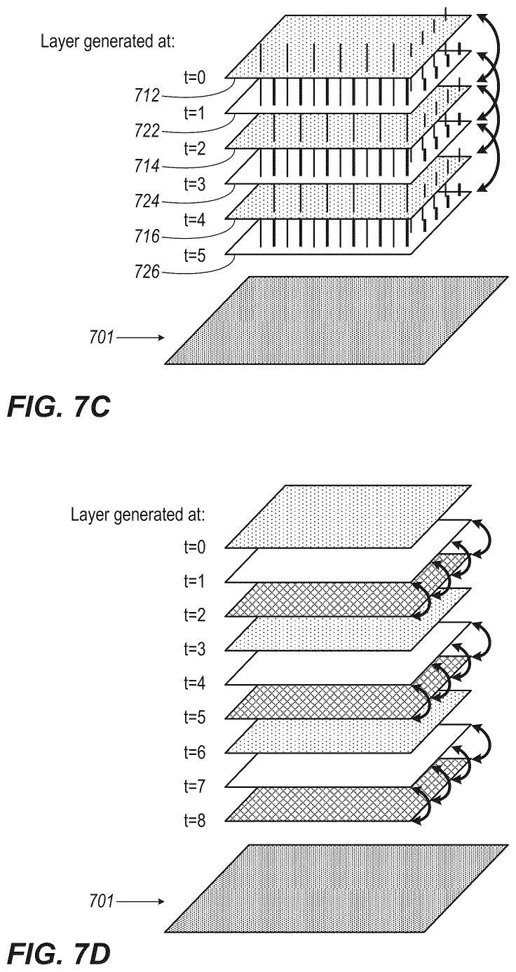

Referring now to FIG. 7A, depicting exemplary layers, in accordance with some exemplary embodiments of the disclosed subject matter.

In some exemplary embodiments, FIG. 7A depicts Layers 700, which may correspond to Layers 612-620 of FIG. 6. In some exemplary embodiments, the set of quantum light sources may periodically generate layers of clusters of optical qubits such as Layers 700.

In some exemplary embodiments, a logical qubit of a quantum program may be represented by a single layer of Layers 700, a plurality of layers within Layers 700, all of Layers 700, a portion of a layer within Layers 700, a portion of a plurality of layers of Layers 700, or the like, referred to as a ‘cluster ensemble’. In some exemplary embodiments, Layers 700 may be fused together over time and/or space, thereby enabling different portions or cluster ensembles of Layers 700 to represent together a logical qubit. In some cases, two or more logical qubits may be represented together by a same cluster ensemble of Layers 700.

In some exemplary embodiments, quantum light sources may be separated into disjoint segments of quantum sources, such that all quantum sources in the lattice may be included in one of the segments. In some exemplary embodiments, layers generated by a segment may be used to represent at least one logical qubit. For example, Segment 701 may be used to generate Layers 700 for representing at least one logical qubit.

In some exemplary embodiments, as the number of quantum sources in a segment increases in size, the error rate of a logical qubit represented by Layers 700 may be reduced, and vice versa. For example, a first segment that includes 10 quantum sources may generate a first set of layers, and a second segment that includes 20 quantum sources may generate a second set of layers. According to this example, a logical qubit represented by the first set of layers may have a higher error rate than a logical qubit represented by the second set of layers, due to the difference in numbers of quantum sources. A tradeoff may exist between the size and quality (in terms of error rates) of cluster ensembles (sets of layers of portions thereof). In the scenario of FIG. 7A, reducing the size of Segment 701 may increase the error rate of a logical qubit represented by layers generated thereby, while increasing the size of Segment 701 may reduce the error rate.

In some exemplary embodiments, in order to represent a logical qubit, a cluster ensemble representing the logical qubit must be entangled, which may limit the generation of cluster ensembles to consecutive layers only. For example, a cluster ensemble that include clusters from non-consecutive layers may not be created, since the clusters will not be entangled with one another. In some exemplary embodiments, in order to overcome this challenge and enable the generation of cluster ensembles on non-successive layers, one or more interleaving techniques may be used, e.g., as depicted in FIG. 7B.

In some exemplary embodiments, an interleaving technique may introduce delay lines between non-consecutive layers, in order to enable entanglement. For example, low-loss photonic delays such as optical fibers may be used to create cluster ensembles from portions of non-consecutive layers, e.g., layers separated by one or more other layers. In some cases, a delay line between layers may be increased in order to interleave layers representing different logical qubits. In some exemplary embodiments, interleaving techniques may be performed according to one or more methods disclosed in H. Bombin et al. “Interleaving: Modular architectures for fault-tolerant photonic quantum computing”. arXiv:2103.08612 (2021), and in U.S. patent application Ser. No. 18/274,957, titled “Interleaving module for fault-tolerant quantum computer”, filed 2022 Jan. 31, which are hereby incorporated by reference in their entirety for all purposes without giving rise to disavowment.

Referring now to FIGS. 7B-7D, depicting exemplary interleaving techniques, in accordance with some exemplary embodiments of the disclosed subject matter.

In some exemplary embodiments, FIG. 7B depicts an exemplary representation of interleaving between non-consecutive layers. In some exemplary embodiments, Segment 701 may periodically generate layers of clusters of optical qubits, e.g., Layers 710 and 720. In some exemplary embodiments, Segment 701 may generate six layers at respective times 0-5, corresponding to Layers 700 of FIG. 7A. For example, Layers 710 may correspond to layers generated at times 0, 2, and 4, while Layers 720 may correspond to layers generated at times 1, 3, and 5. In order to allow the generation of a cluster ensemble between portions of non-consecutive layers, such as between portions of Layers 710, the delays between layers may be increased, such as by increasing a length of optical fibers between the layers.

For example, a cluster ensemble may be generated to comprise a portion of a first layer of Layers 710 (e.g., generated at time 0), and a portion of a second layer of Layers 710 (e.g., generated at time 2). Since the first and second layers of Layers 710 are non-consecutive layers, and the cluster ensemble requires entanglement, the cluster ensemble may be generated using interleaving techniques. In some exemplary embodiments, interleaving techniques may be employed to generate any other cluster ensemble comprised of clusters separated by any other number of non-consecutive layers. For example, the delay between layers may be increased by three, in order to generate a cluster ensemble separated by two layers.

As another example, a first cluster ensemble may be generated to comprise Layers 710, and a second cluster ensemble may be generated to comprise Layers 720. According to this example, the first cluster ensemble may represent one or more first logical qubits, while the second cluster ensemble may represent one or more second logical qubits. In other cases, the allocation of logical qubits to cluster ensembles may be performed in any other way, and the allocation of Layers 710 and 720 to cluster ensembles may be performed in any other way.

In some exemplary embodiments, FIG. 7C depicts the interleaved non-consecutive layers, e.g., Layers 710 and 720, with the added delay lines. For example, Layers 712, 714, and 716 may correspond to the layers of Layers 710 in FIG. 7B, and Layers 722, 724, and 726 may correspond to the layers of Layers 720 in FIG. 7B. In some exemplary embodiments, Layers 712 and 714 may be interleaved, Layers 714 and 716 may be interleaved, Layers 722 and 724 may be interleaved, and Layers 724 and 726 may be interleaved, e.g., as indicated by the depicted errors. In some exemplary embodiments, this configuration may enable to generate a cluster ensemble for portions of non-consecutive layers, separated by a single layer (interleaving depth of ‘1’).

In some exemplary embodiments, FIG. 7D depicts an interleaving depth of three. In some cases, interleaving may be used for any number of layers separating non-consecutive layers. For example, in addition to interleaving non-consecutive layers separated by a single layer (e.g., interleaving depth of ‘1’), such as in the scenario of FIGS. 7B-7C, non-consecutive layers may be interleaved by a depth of two layers, three layers, or any other number of layers, time steps, delay lines, or the like. FIG. 7D depicts a scenario of interleaving non-successive layers separated by two layers (interleaving depth of ‘2’).

In some exemplary embodiments, Segment 701 may periodically generate nine layers of clusters of optical qubits, e.g., at times 0-8. In some exemplary embodiments, non-consecutive layers separated by two layers may be interleaved. For example, a layer generated at time 0 may be interleaved with a layer generated at time 3, which, in turn, may be interleaved with a layer generated at time 6. As another example, a layer generated at time 1 may be interleaved with a layer generated at time 4, which, in turn, may be interleaved with a layer generated at time 7. As another example, a layer generated at time 2 may be interleaved with a layer generated at time 5, which, in turn, may be interleaved with a layer generated at time 8. In some exemplary embodiments, this configuration may enable to generate a cluster ensemble for portions of non-consecutive layers, separated by two layers. In other cases, any other number of layers may separate the non-consecutive layers.

In some exemplary embodiments, in some cases, a first set of interleaved layers, such as including layers generated at times 1, 4, and 7, may be interleaved with one another, entangled with one another, or the like. In some cases, addition fusion processes may be applied to entangle the first set of interleaved layers with other sets of interleaved layers. For example, as depicted in FIG. 7D, fusion processes may be applied at the border of the first set of interleaved layers and a second set of interleaved layers (generated at times 2, 5, and 8). As exemplified in this example, the delay lines of the applied interleaving depth may not limit the ability to entangle or fuse together different sets of interleaved layers.

In some exemplary embodiments, the tradeoff between the size and quality (in terms of error rates) of cluster ensembles may be affected by the use of interleaving techniques. For example, as the number of layers that separate non-consecutive layers of a cluster ensemble is greater, the delay lines (e.g., optical fibers) between the non-consecutive layers must be increased in length, which, in turn, may increase an error rate of any logical qubits represented by the cluster ensemble. In some exemplary embodiments, as the length of optical fibers increases, more optical data may be swallowed by the optical fibers, reducing the accuracy of the quantum states held by the cluster ensemble. In some exemplary embodiments, photons carrying quantum information may be dissipated or attenuated as they propagate through the optical fibers, due to various factors such as absorption, scattering, or leakage of photons from the intended path. For example, photons carrying quantum information may be absorbed, trapped, captured, or the like, by the optical fiber, which may adversely affect the fidelity and efficiency of quantum operations. In some cases, an increased error rate may be compensated by a larger segment (having a larger number of quantum sources).

In some exemplary embodiments, managing and minimizing the loss of quantum information in optical systems may be crucial for the effective implementation of optical qubit-based technologies. In some exemplary embodiments, it may be desired to find a balance, such as an optimal balance, between the size, interleaving depth, and error rate of cluster ensembles. In some exemplary embodiments, the tradeoff may be affected also by the number of logical qubits represented by a cluster ensemble, e.g., as more logical qubits reducing the size-per-logical qubit of the cluster ensemble, which may in turn increase the error rate.

In some exemplary embodiments, in order to provide an optimal implementation of a quantum program on an optical quantum computer, the logical qubits of the quantum program may be allocated to cluster ensembles according to one or more optimization functions. In some exemplary embodiments, an optimization functions may take into account a plurality of factors, such as the performance of a plurality of cluster ensembles that represent the logical qubits, a cost of each gate operation of the program when implemented between the cluster ensembles, or the like. In some cases, a performance of a cluster ensemble may be affected by a plurality of factors, such as the overall size of the cluster ensemble, size-per-logical qubit, interleaving depth, and error rate. In some cases, these factors may be factored into a processing stage of an optimization function.

In some exemplary embodiments, an optimization function may be configured to reduce one or more cost functions, objective functions, or the like, measuring a cost or a number of resources of an implementation of a quantum program. In some cases, the cost function may be customized by a user, to represent the cost of each resource, error rate, execution, or the like, in the eyes of the user. For example, the user may wish to minimize executions on the expense of using a larger number of optical qubits. In other cases, the cost function may not be set by the user, and may be pre-configured according to one or more rules, heuristics, or the like.

In some cases, a cost function may be configured to measure a cost in terms of execution time, number of executions, number of cycles, number of gate operations, number of measurements, types of operations (e.g., a cost of different gates may differ depending of the operation type, order, distance between cluster ensembles, or the like), number of overall quantum sources, a length of delay lines such as optical fibers for each cluster ensemble, estimated error rates per logical qubit, estimated overall error rate, a number of layers, or the like. For example, temporal multiplexing or fusions may have a different cost, in terms of resource utilization, than spatial multiplexing. As another example, a cost of a gate operation between two logical qubits may be affected by the physical distance between the clusters that are allocated to represent each logical qubit, thus resulting with non-uniform costs of gate and measurement operations.

In some cases, a cost function may be configured to weigh different factors using one or more weighting schemes, functions, or the like, e.g., provided by the user, by predefined rules, list, or the like. For example, the cost function may or may not be set by the user to include default settings (e.g., default weights). In some cases, the cost function may assign the same or different weights to different resources, properties, error rates, or the like.

In some cases, the optimization function may be configured to adhere to one or more constraints, such as a maximal error rate that the user allows. For example, the constraints may comprise a target error rate for each logical qubit, a constraint on an overall error rate, hardware constraints, a maximal error rate that is tolerable to the user, maximum execution time, a minimal or maximal number of quantum sources that should be used, an objective function of the user, a program constraint, or the like. In some cases, the constraints may be defined or customized by the user, obtained from a third-party, obtained from another entity besides the user, from a third-party entity, from a server, or the like.

In some exemplary embodiments, one or more constraints may be determined automatically, e.g., based on the quantum program. For example, a target error rate may be determined by analyzing a quantum program, and determining which logical qubits are used as output, which logical qubit hold important information, or the like, and assigning such logical qubits a lower target error rate than other qubits, e.g., according to preconfigured rules. As another example, a program constraint, such as a precedence constraint between gate operations, may be determined automatically based on analyzing the program. In some exemplary embodiments, constraints may comprise local constraints, global constraints, or the like. For example, an overall number of quantum sources in an execution platform that is available may constitute a global hardware constraint.

In some cases, the optimization function may be configured to reach a defined balance between quantum resources, error rates, or the like, e.g., reflecting the user's desired tradeoff or a pre-configured tradeoff. For example, the optimization function may be configured to determine an implementation of a quantum program that results with a minimal cost while adhering to constraints. As another example, the optimization function may be configured to minimize or maximize a parameterized objective function. As another example, the optimization function may be configured to provide valuations that comply with all of the hardware constraints, user constraints, constraints defined by the quantum program, or the like, while reducing a weighted or non-weighted cost function, an objective function, or the like.

In some exemplary embodiments, the optimization function may obtain, as input, a logical representation of a quantum program, one or more constraints of the photonic-based quantum computer, one or more user constraints (e.g., on the error rate), one or more tradeoff ratios that the function should aim to achieve, or the like. For example, the constraints of the photonic-based quantum computer may comprise hardware constraints of a quantum execution platform over which the quantum program is scheduled to be executed (e.g., a target photonic-based quantum computer), such as an overall number of available quantum sources, gate and measurement operations that are applicable by the quantum execution platform, or the like. In some cases, the logical representation of the quantum program may comprise a Directed Acyclic Graph (DAG) representation, in which nodes represent operations and edges represent precedence constraints.

In some exemplary embodiments, the optimization function may process the provided data, and provide based thereon an “allocation scheme”, such as valuation of a set of parameters that represent an optimal implementation of the quantum program. For example, the valuation of the parameters may define an allocation of quantum sources to segments, the number of segments, the size of each segment, the indices of quantum sources allocated to each segment, an allocation of logical qubits to cluster ensembles of segments of the optical quantum computer, the number of cluster ensembles per segment, an allocation of gate operations between the cluster ensembles, an order of the operations, an overall number of quantum sources allocated to the program, or the like.

In some cases, implementations of the quantum program may be determined using one or more techniques disclosed in I. H. Kim et al. “Fault-tolerant resource estimate for quantum chemical simulations: Case study on Li-ion battery electrolyte molecules”. arXiv:2104.10653v2 (2023). arxiv.org/pdf/2104.10653, in U.S. Pat. No. 11,847,020B1, titled “Methods and devices for decoding quantum states”, filed 2022 Mar. 1, and in U.S. patent application Ser. No. 17/555,238, titled “Photonic quantum computer architecture”, filed 2021 Dec. 17, which are hereby incorporated by reference in their entirety for all purposes without giving rise to disavowment.

It is noted that the term ‘optimal’ or ‘optimized’, as used herein, may refer to a solution that comprises a global optimum, a local optimum, or neither. In some cases, an optimal solution may refer to a solution that complies with one or more thresholds, complies with one or more constraints, is within a defined range of sufficiently good results, is within a defined percentile of the results, or the like.

For example, the set of parameters may comprise a parameter that defines, for each segment, a number of cluster ensembles represented thereby, with a corresponding domain. For example, the domain may be defined to include a range of 1-4, in case the optical fibers of the platform have a length that can be used to represent up to four logical qubits, or any other range corresponding to other hardware constraints of optical systems. As another example, the set of parameters may comprise a parameter that defines an order of gate implementations, layers of segments during which gates should be implemented, a type of fusion that should be used for implementing a gate, or the like, all of which incurring respective costs.

It is noted that different allocations of cluster ensembles and their order in time may affect the cost of applied fusion processes between the cluster ensembles. For example, first and second logical qubits may be represented by cluster ensembles of a first segment, and third and fourth logical qubits may be represented by cluster ensembles of a second segment that is adjacent to the first segment. According to this example, the first logical qubit may be represented by a cluster ensemble that comprises a first layer generated by the first segment, and the second logical qubit may be represented by a cluster ensemble that comprises a subsequent layer. Simultaneously, the third logical qubit may be represented by a cluster ensemble that comprises a first layer of the second segment, and the second logical qubit may be represented by a cluster ensemble that comprises a subsequent layer. In case a logical gate is scheduled by the quantum program to be performed between the first and third logical qubit, the cost of the gate may be low, since the first and third cluster ensemble may be adjacent, as they are generated at a same timestamp, enabling swift fusion processes therebetween. In case a logical gate is scheduled by the quantum program to be performed between the first and fourth logical qubit, the cost of the gate may be higher, since the first and fourth cluster ensemble have different timestamps and are thus not adjacent, requiring additional resources to perform fusion processes therebetween.

In some exemplary embodiments, the valuation of the set of parameters may be configured to comply with the constraints. For example, in case a constraint of the optimization function defines that the target error rate for a specified logical qubit of the quantum program is limited to 1E-10, the cluster ensemble allocated for representing the state of the logical qubit may be required to comprise at least 81 clusters in order to adhere with this constraint. This may be accomplished in various alternative manners, e.g., by allocating a layer of 9×9 clusters to the qubit (generated by a respective 9×9 segment), by allocating a layer of 15×15 clusters to a pair of qubits that includes the logical qubit and a second logical qubits (including 225 clusters generated by a respective 15×15 segment), by allocating clusters from different consecutive layers, by allocating clusters from different non-consecutive using interleaving, or the like.

In some exemplary embodiments, the optimization function may use one or more constraint solvers, heuristic algorithms, predictors, or the like, to search for valuations of the set of parameters that complies with the constraints and minimizes the cost function, valuations that adhere to user-defined ratios or tradeoffs, or the like. For example, the optimization function may define a Constraint Satisfaction Problem (CSP) that corresponds to the set of parameters, its domains, its constraints, or the like. According to this example, global and local constraints may be added to the CSP problem as constraints, and the domains of the parameters may be adjusted to correspond to the constraints.

In some exemplary embodiments, the optimization function may utilize a CSP solver to solve the CSP, thereby obtaining a valuation of the parameters that represents an allocation scheme that minimizes the objective function while complying with the local constraints, global constraints, or the like. In other cases, any other optimizer or constraint solver may be utilized in addition to or instead the CSP solver. In some exemplary embodiments, the CSP solver may be configured to terminate its execution upon identifying one set of valuations for the set of parameters that complies with all the constraints and optimizes, locally or globally, on the objective function, or may be configured to terminate upon identifying all of the possible sets of valuations, a subset thereof, a defined number of valuations, or the like.

In some cases, a CSP solver may be executed on a classical computing device that may not necessarily have sufficient computational resources for solving the CSP during a single execution. In such cases, the optimization problem may be separated into a plurality of stages, which may or may not be executed sequentially, consecutively, simultaneously, separately, a combination thereof, or the like, in order to detect an optimal allocation scheme. For example, a CSP solver may be executed in two or more iterations over subsets of the solution space, a heuristics solver may be executed in two or more iterations, or the like.

In some cases, the optimization function may deploy one or more search algorithms in order to select an optimal valuation. For example, the search algorithms may be employed in a solution space that includes the domains of each parameter, constraints thereof, or the like, such that each valuation that complies with the constraints represents a different feasible implementation of the quantum circuit. In some cases, a search algorithm may be configured to terminate upon finding one or more sets of valuations for parameters that comply with the constraints and domains, and minimizes the cost function. In some cases, the search algorithms may utilize a predictor to predict the error rates, execution time, or the like, of implementations associated with different valuations of parameters, and assign a cost to the valuation based on the predictions.

In some exemplary embodiments, based on the CSP solver, the search algorithms, or the like, the optimization function may be configured to output at least one valuation for the set of parameters, which complies with all the constraints, and optimizes, locally or globally, on the objective or cost function. In some exemplary embodiments, the set of valuations may represent an optimal allocation scheme that is feasible, which reduces the resource utilization, which is estimated to obtain a lowest error rate, a defined balance between them, or the like, e.g., as defined by the objective function.

In some exemplary embodiments, the optimization function may allocate resources and logical qubits to segments as part of a static error correction scheme, or dynamically as part of a dynamic error correction scheme. For example, quantum sources may be dynamically assigned to different segments throughout an execution of a quantum program. As another example, clusters assigned to a cluster ensemble of a logical qubit may be dynamically adjusted during an execution of a quantum program, e.g., by adding or removing clusters thereto. As another example, a logical qubit assigned to a cluster ensemble may be dynamically assigned to a different cluster ensemble during an execution of a quantum program.

In some exemplary embodiments, the determined allocation scheme may or may not comprise dynamic adjustments such as changes to segments' positions, sizes, representations of logical qubits, or the like, during runtime. In some exemplary embodiments, constraints of the set of parameters, which dictate their domains, may define whether or not each parameter can be dynamically changed during execution, how each parameter can be adjusted, to what extent the parameter can be adjusted, or the like.

In some exemplary embodiments, in case of a dynamic error correction scheme, the cost function may be adjusted to assign a cost of each dynamic operation, dynamic adjustment, or the like. In some cases, a cost of each dynamic adjustment may be compared to the cost of not performing the dynamic adjustment, and the optimization function may be configured to schedule a dynamic adjustment only in case that the cost of the dynamic adjustment is lesser than the cost of not performing the dynamic adjustment. In some cases, the optimization function may be configured to schedule a dynamic adjustment only in case that the cost of the dynamic adjustment is lesser by at least a threshold compared to the cost of not performing the dynamic adjustment.

One technical effect obtained by the disclosed subject matter is enabling to implement an error correction scheme such as surface code for MBQC-based quantum programs. The disclosed subject matter provides a framework for allocating cluster ensembles to represent each logical qubit of the program, and for allocating fusion operations between cluster ensembles to represent logical gates between logical qubits and periodical surface code measurements.

Another technical effect obtained by the disclosed subject matter is enabling to implement a quantum program with enhanced efficiency in MBQC frameworks. In some cases, the disclosed subject matter enables users to provide their own objective function, cost function, or the like, and to generate an implementation that optimizes on their objective function, e.g., using a CSP solver. In some exemplary embodiments, the optimization function enables to take into account various factors such as a cost of temporal fusions, a cost of spatial fusions, or the like, and to generate a customized implementation that matches each obtained quantum program.

Yet another technical effect obtained by the disclosed subject matter is enabling to allocate resources in a non-unfirm manner, in order to increase the effectiveness of the execution, reduce the error rate, and reduce the cost of the implementation. For example, the disclosed subject matter enables to represent a first number of logical qubits by layers of a first segment of quantum sources, and to represent a second, different, number of logical qubits by layers of a second segment of quantum sources. As another example, the disclosed subject matter enables to bin quantum sources into non-uniform segments, according to the needs and requirements of each quantum program.

Yet another technical effect obtained by the disclosed subject matter is utilizing optimizers such as CSP solvers and search algorithms to dynamically generate optimized implementations of quantum programs. For example, by representing the space of possible implementations using a set of parameters, a plurality of constraint solvers may be used to find a valuation that provides optimized results.

Yet another technical effect obtained by the disclosed subject matter is providing a dynamic error correction scheme that enables to dynamically adjust allocations during an execution of a quantum program. The disclosed subject matter may provide for one or more technical improvements over any pre-existing technique and any technique that has previously become routine or conventional in the art. Additional technical problems, solutions, and effects may be apparent to a person of ordinary skill in the art in view of the present disclosure.

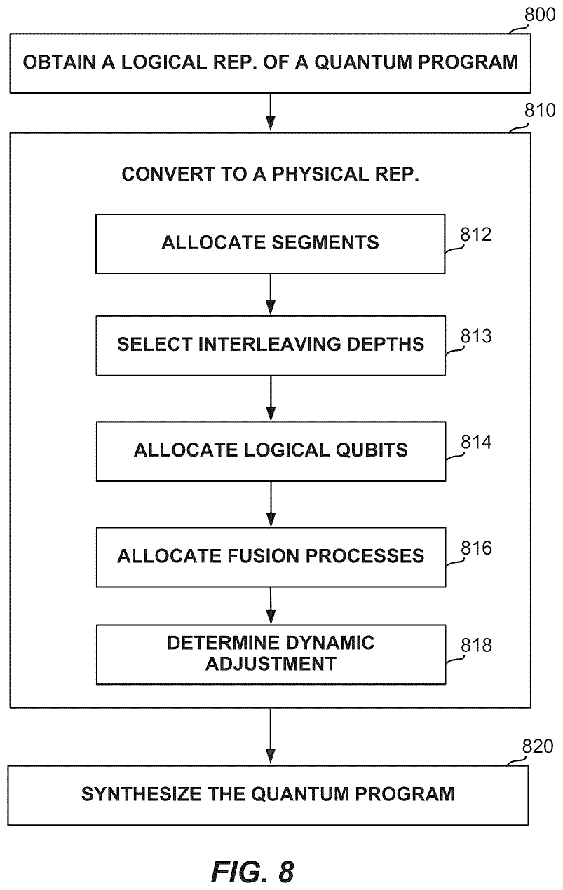

Referring now to FIG. 8, showing an exemplary flowchart diagram of a method, in accordance with some exemplary embodiments of the disclosed subject matter.

On Step 800, a logical representation of a quantum program may be obtained. In some exemplary embodiments, the logical representation may define a plurality of logical qubits, a plurality of gate operations on subsets of the logical qubits, or the like. In some exemplary embodiments, the logical representation may be configured to provide an output via one or more logical output qubits, and error rates of the logical output qubits may correspond to the error rate of the quantum program.

In some cases, the logical representation of the quantum program may comprise a Directed Acyclic Graph (DAG), in which nodes represent the gate operations, and edges between the nodes represent precedence constraints between the plurality of gate operations. In other cases, the logical representation of the quantum circuit may be represented in any other form, graph, or the like.

On Step 810, the logical representation may be converted to a physical representation of the quantum program. In some exemplary embodiments, the physical representation may be configured to be synthesized and executed on an execution platform such as a photonic quantum computer. It is noted that the disclosed subject matter is exemplified with relation to a photonic quantum computer with optical qubits, but it is not limited to such computer type. As an example, the disclosed subject matter may be applied on measurement-based quantum computer that is not optical, a fusion-based quantum computer that is not optical, or the like. Any reference to a photonic quantum computer herein may be considered interchangeable with a measurement-based quantum computer and/or a fusion-based quantum computer. Any reference to optical qubits herein may may be considered interchangeable with non-optical physical qubits. In some exemplary embodiments, the physical representation may comprise determining an allocation of resources of a photonic quantum computer to implement the quantum program (the ‘allocation scheme’). For example, the program may be implemented using an error correction scheme such as surface code.

In some exemplary embodiments, the logical representation may be converted to the physical representation based on an optimization function, constraints, or the like. In some exemplary embodiments, the constraints may comprise hardware constraints of the photonic quantum computer, program constraints of the quantum program, user constraints such as error rate constraints, or the like. For example, the photonic quantum computer may comprise resources such as a plurality of quantum light sources for periodically generating clusters of optical qubits, fusion processes that can be applied thereby, or the like, and the hardware constraints may comprise constraints on a number of available quantum sources, on numbers and types of fusion processes per layer, on cluster generation (e.g., on quits-per-cluster), constraints on a number of logical qubits that can be represented by cluster ensembles, or the like. As another example, the error rate constraints may limit an estimated error rate of a quantum program that results from the allocation of resources. As another example, the program constraints may comprise precedence constraints between gate operations.

In some exemplary embodiments, the optimization function may utilize one or more constraint solvers, heuristic algorithms, predictors, or the like, to determine the allocation scheme. In some exemplary embodiments, the optimization function may define a CSP that corresponds to the quantum program, and comprises variables, domains and constraints. In some exemplary embodiments, each variable may have a corresponding domain that defines potential values of the variable. For example, variables may be defined to represent the number and indices of segments, a division of segment layers into cluster ensembles that represent logical qubits, an allocation of logical qubits to cluster ensembles, a selection of a number of logical qubits per cluster ensemble, an order and type of fusion processes to be performed between cluster ensembles, or the like. In some exemplary embodiments, the constraints may define one or more constraints on values of the variables or portion thereof, such as precedence constraints between the plurality of gate operations (e.g., of the DAG), hardware constraints, user constraints, error rate constraints, or the like. For example, the hardware constraints may define a limit on the number of logical qubits that can be represented by a cluster ensemble.

In some exemplary embodiments, the optimization function may be configured to extend the CSP to incorporate a Constraint Optimization Problem (COP). For example, the COP may be configured to minimize an objective function such as a cost function that is defined with respect to the variables, domains and constraints of the CSP. In some exemplary embodiments, the cost function may be configured to measure one or more resources that are used for a physical representation of the program, such as a quantity of quantum light sources that are allocated to the physical representation, an error rate, a number of cycles, a number of fusion processes, or the like. In some cases, different fusion processes may have different costs. For example, a fusion over space (e.g., spatial multiplexing) may utilize more or less resources that a fusion over time (e.g., temporal fusion). In some exemplary embodiments, fusion processes may comprise applications of fusion gates, unitary gates, or the like, between cluster ensembles, which may affect the number of cycles of the execution. In some exemplary embodiments, the cost function may or may not apply one or more weighting schemes to allocate different weights to different resources, e.g., according to a user's preference, a predefined setting, sub-components of resources, one or more rules, or the like.

In some exemplary embodiments, the optimization function may utilize a CSP solver (or a COP solver) to solve the extended CSP, in order to obtain a solution that represents an implementation of the quantum program that complies with the constraints while minimizing the cost function. For example, the CSP solver may utilize exact methods such as linear programming, branch and bound, and dynamic programming, heuristic methods such as genetic algorithms, simulated annealing, and local search, or the like.

In some exemplary embodiments, the conversion of the logical representation into the physical representation may be performed according to Sub-Steps 812-818. It is noted that although Sub-Steps 812-818 are described as subsequent steps, they may be performed simultaneously, at overlapping timeframes, or the like. For example, applying a CSP solver may comprise a single iteration or execution that provides a valuation of the CSP variables that incorporates Sub-Steps 812-818. As another example, such as in case of high complexity, the processing may be performed in a sequential manner, such as by applying CSP solvers on parts of the CSP problem or generating partial solutions (e.g., reducing domains of variables), until the entire valuation is obtained. According to this example, Sub-Steps 812-818 may be performed in any order.

On Sub-Step 812, at least a subset of the quantum light sources of the photonic quantum computer may be allocated to a plurality of segments. In some exemplary embodiments, a segmentation of the quantum sources into a plurality of disjoint segments may be determined, e.g., using the CSP solver.

In some exemplary embodiments, the disjoint segments may be configured to generate consecutive layers of clusters of optical qubits, which may be separated by respective time delays. In some exemplary embodiments, each segment may be configured to periodically generate one layer of clusters at a time. For example, a segment may generate consecutive layers of clusters every millisecond, every two milliseconds, every second, or the like. In some exemplary embodiments, the layers generated by the segments may be configured to represent the logical qubits of the logical representation (e.g., input qubits, auxiliary qubits, output qubits, or the like).

In some exemplary embodiments, the segments may be disjoint, e.g., no quantum light source in the plurality of quantum light sources may belong to more than one segment, but some may not be allocated to any segment. For example, in case two programs are executed simultaneously over the photonic quantum computer, some quantum sources may not be allocated to the quantum program.

In some exemplary embodiments, the allocation of the quantum light sources may be performed by allocating, for each segment, a size in terms of number of quantum sources, indices of quantum sources allocated to the segment (e.g., indicating a relative location of the segment in a plane of the plurality of quantum sources), a dynamic adjustment of the size during execution of the quantum program, a dynamic adjustment of the indices during execution of the quantum program, other properties of the segments, or the like. In some exemplary embodiments, the allocation may be determined based on an optimization function, the logical representation, constraints of the photonic quantum computer or any other quantum execution platform, or the like.

In some exemplary embodiments, the allocation of the quantum sources may be non-uniform. For example, a first segment may be allocated a first numbers of quantum sources while a second segment may be allocated a second numbers of quantum sources. According to this example, the first number of quantum sources may differ from the second number of quantum sources.

On Sub-Step 813, interleaving depths may be allocated or selected for the plurality of segments. In some exemplary embodiments, for each segment of the plurality of disjoint segments, or for portion thereof, an interleaving depth may be selected from a plurality of interleaving depths that are supported by the photonic quantum computer. For example, the CSP may comprise a variable that represents the interleaving depth of each segment, and the domain of the variable may be set by hardware limitations of the target photonic quantum computer.

In some exemplary embodiments, the interleaving depths may correspond to lengths of delay lines between non-consecutive layers generated by each segment, e.g., as described with respect to FIGS. 7B-7D. In some exemplary embodiments, the lengths of the delay lines may be longer for greater interleaving depths, and shorter for lesser interleaving depths. For example, an interleaving depth of zero may indicate that no interleaving is performed, an interleaving depth of one may indicate that an interleaving is performed with one layer of separation (e.g., similar to FIG. 7C), an interleaving depth of two may indicate that an interleaving is performed with two layers of separation (e.g., similar to FIG. 7D), and so on. In some exemplary embodiments, the delay lines may comprise optical fibers or any other suitable material.

In some exemplary embodiments, the selected interleaving depths may result with respective sets of layers that are entangled with one another. For example, an interleaving depth of one may result with two sets of layers of a segment, one set including the non-consecutive layers generated by the segment at even time slots, and the second set including the non-consecutive layers generated by the segment at odd time slots. As another example, an interleaving depth of two may result with three sets of non-consecutive layers of a segment. The non-consecutive layers of each set may be entangled with one another via the respective delay lines. The layers of a set may or may not be entangled with layers of other sets.

In some exemplary embodiments, the allocation of the interleaving depths to segments may be non-uniform. For example, a first interleaving depth may be selected for non-consecutive layers of a first segment, and a second interleaving depth may be selected for non-consecutive layers of a second segment. According to this example, the first and second interleaving depths may be different, resulting with a non-uniform distribution of interleaving depths between the disjoint segments

On Sub-Step 814, a number and identity of logical qubits may be allocated to each of the plurality of segments. In some exemplary embodiments, for each segment of the plurality of disjoint segments, one or more logical qubits of the plurality of logical qubits may be selected to be represented by clusters generated by the segment. In some exemplary embodiments, the allocation of logical qubits to segments may be determined based on factors such as the interleaving depths of the segments, the sizes of the segments, the logical representation of the program, constraints of the photonic quantum computer, the number of logical qubits in the quantum program, or the like.

In some exemplary embodiments, for each logical qubit, one or more layers or portion thereof (a cluster ensemble) generated by a segment may be selected for representing the logical qubit. In some exemplary embodiments, a cluster ensemble may comprise a set of clusters of optical qubits, in one or more successive layer, non-successive layers (connected through interleaving), or the like. For example, a cluster ensemble may comprise a set of clusters of optical qubits from one or more non-consecutive layers generated by a segment, in which the layers are interleaved according to a selected interleaving depth. In some cases, the clusters from the cluster ensemble that belong to non-consecutive layers may be entangled, fused, or the like, by using the delay lines of the first interleaving depth.

In some exemplary embodiments, a cluster ensemble generated by a segment may be allocated for representing a single logical qubit, a register of logical qubits, or the like. For example, a single cluster ensemble may be selected for representing two or more logical qubits. As another example, a single cluster ensemble may be selected for representing a single logical qubit.

On Sub-Step 816, one or more fusion processes may be allocated to respective gate operations of the logical representation, periodic measurements operations of the surface code, or the like. In some exemplary embodiments, fusion processes may comprise fusion gates, unitary gates, unitary transformations, measurements, or the like. In some cases, an order between scheduled fusion processed may be determined, e.g., by the optimization function.

In some exemplary embodiments, for each gate operation that is configured by the logical representation to be applied on subsets of logical qubits, one or more fusion processes may be allocated. In some exemplary embodiments, the fusion processes may be scheduled to be performed between one or more cluster ensembles representing respective logical qubits. In some exemplary embodiments, the allocation of fusion processes may affect a number of cycles required for executing the synthesized quantum program. For example, as the cluster ensembles that are scheduled to perform fusion processes are more adjacent, the application of fusion processes may be easier and faster, resulting with less execution cycles. The same may be true vice versa.

In some exemplary embodiments, a first set of fusion processes may be used to represent gate operations, and a second disjoint set of fusion processes may be used to represent surface code measurements. In some exemplary embodiments, one or more fusion processes may be used simultaneously to represent gate operations and surface code measurements. For example, fusion processes may be allocated to implement surface code measurements every defined period. In some cases, in case a fusion operation that represents a logical gate can replace a surface code measurement, the fusion operation may be used for both, while in case a surface code measurement is missing, a dedicated fusion operation may be added to implement the surface code measurement.

For example, a first cluster ensemble generated by the first segment may be allocated to represent a first logical qubit, and a second cluster ensemble generated by the first segment may be allocated to represent a second logical qubit. According to this example, a fusion process may be allocated or scheduled between the first and second cluster ensemble. In another scenario, the second cluster ensemble may be generated by a different segment, e.g., a second segment. Since cluster ensembles may be positioned on the time-space axis, a distance (e.g., in terms of physical distance or path distance) between cluster ensembles may be inferred from the allocation of cluster ensembles themselves. In some exemplary embodiments, the distance between cluster ensembles may affect the fidelity and efficiency of quantum operations and information transfer during an execution of the quantum program.

On Sub-Step 818, one or more dynamic adjustments may or may not be determined. In some exemplary embodiments, an allocation of resources determined in any other the above steps may be scheduled to dynamically adjusted during the program execution (of the synthesized program). For example, number and/or identity of quantum sources allocated to a segment may be determined to be dynamically adjusted during the program execution, e.g., after a start of the execution of the circuit, such as at an intermediate cycle.

In some exemplary embodiments, an allocation may be determined to be dynamically adjusted based on the cost the dynamic adjustment. For example, the cost function may measure the cost of the dynamic adjustment, and the optimization function may compare the cost of the program with and without the dynamic adjustment. According to this example, in case the benefit of the dynamic adjustment is not significant (e.g., below a delta threshold), the dynamic adjustment may not be included in the physical representation. In some exemplary embodiments, the dynamic adjustments may be determined based on an optimization function, a CSP solver, constraints of the photonic quantum computer, program constraints, the number of logical qubits in the quantum program, or the like.

In some exemplary embodiments, resources that may be dynamically adjusted may comprise a property of a segment, such as its size, indices, and logical qubits represented thereby. In some exemplary embodiments, resources that may be dynamically adjusted may comprise any other properties such as an allocation of fusion processes, an allocation of cluster ensembles, an interleaving depth of each segment, or the like.

On Step 820, the quantum program may be synthesized according to the allocation scheme of the physical representation, whereby a synthesized quantum program is optimized according to the optimization function. In some exemplary embodiments, a synthesized quantum program may be executable on the photonic quantum computer.

In some exemplary embodiments, synthesizing the quantum program may comprise utilizing a CSP solver to solve the CSP that represents the different possible implementations of the quantum program, and generating based on the valuation of the CSP, a machine-readable format of the selected implementation. In some exemplary embodiments, a solution of the CSP may enable to generate a synthesized quantum program using a compiler or any other classical processing unit. In some exemplary embodiments, the synthesized quantum program may be simulated, executed, or the like, e.g., on a photonic quantum computer.

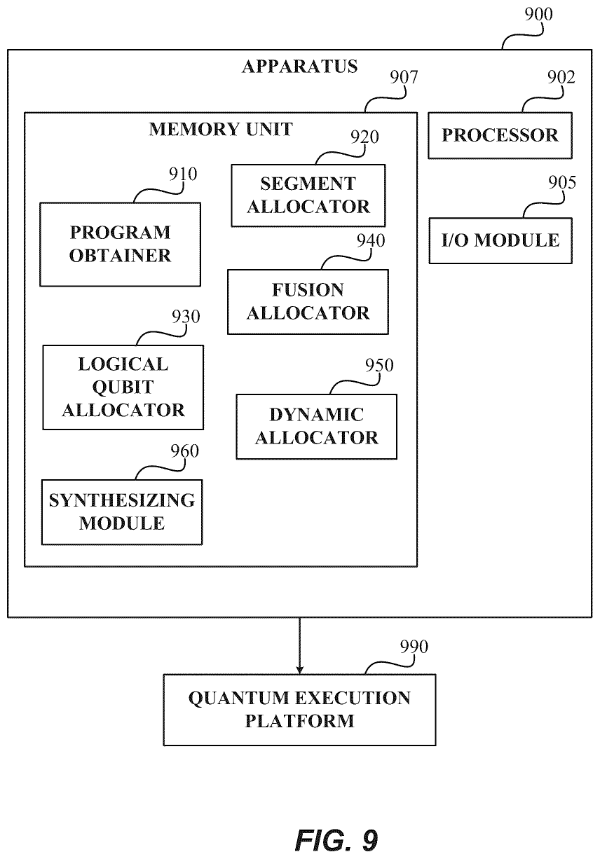

Referring now to FIG. 9 showing a block diagram of an apparatus, in accordance with some exemplary embodiments of the disclosed subject matter.

In some exemplary embodiments, Apparatus 900 may comprise one or more Processor(s) 902. Processor 902 may be a Central Processing Unit (CPU), a microprocessor, an electronic circuit, an Integrated Circuit (IC) or the like. Processor 902 may be utilized to perform computations required by Apparatus 900 or any of its subcomponents. It is noted that Processor 902 may be a traditional classical processor, and not necessarily a quantum processor.

In some exemplary embodiments of the disclosed subject matter, Apparatus 900 may comprise an Input/Output (I/O) module 905. I/O Module 905 may be utilized to provide an output to and receive input from a user, an apparatus, or the like, such as, for example to obtain a user-defined quantum program, to obtain a user-defined objective function, to obtain a user-defined cost function, to obtain a user-defined weighting scheme, to obtain a user-defined ratio of resources per error, showing circuit illustrations, communicating with quantum hardware, or the like.

In some exemplary embodiments, Apparatus 900 may comprise Memory 907. Memory 907 may be a hard disk drive, a Flash disk, a Random Access Memory (RAM), a memory chip, or the like. In some exemplary embodiments, Memory 907 may retain program code operative to cause Processor 902 to perform acts associated with any of the subcomponents of Apparatus 900. Memory 907 may comprise one or more components as detailed below, implemented as executables, libraries, static libraries, functions, or any other executable components.

In some exemplary embodiments, Memory 907 may comprise a Program Obtainer 910. Program Obtainer 910 may obtain a quantum program, e.g., a logical representation of a quantum circuit, from a user, a server, a computing device, or the like. Program Obtainer 910 may obtain the quantum program via I/O Module 905.

In some exemplary embodiments, Memory 907 may comprise a Segment Allocator 920, which may be configured to allocate quantum sources to a set of segments. In some exemplary embodiments, each segment may be configured to generate sequential layers of qubit clusters, which may represent one or more logical qubits. In some exemplary embodiments, Segment Allocator 920 may determine properties of the segments, such as their sizes, positions, indices, or the like.

In some exemplary embodiments, Memory 907 may comprise a Logical Qubit Allocator 930, which may be configured to map or allocate logical qubits to one or more cluster ensembles generated by a segment. For example, layers of a segment determined by Segment Allocator 920 may be divided into one or more cluster ensembles. In some exemplary embodiments, Logical Qubit Allocator 930 may allocate one or more logical qubit to each cluster ensemble.

In some exemplary embodiments, Memory 907 may comprise a Fusion Allocator 940. In some exemplary embodiments, Fusion Allocator 940 may allocate one or more fusion processes such as gates and measurements between cluster ensembles. In some exemplary embodiments, Fusion Allocator 940 may determine one or more orders of execution of the fusion processes.

In some exemplary embodiments, Memory 907 may comprise a Dynamic Allocator 950. In some exemplary embodiments, Dynamic Allocator 950 may be configured to determine one or more adjustments in properties of the segments, in allocations of logical qubits, in properties of cluster ensembles, or the like.

In some exemplary embodiments, Memory 907 may comprise a Synthesizing Module 960, configured to synthesize quantum circuits according to the allocated resources. In some cases, Synthesizing Module 960 may be configured to execute synthesized quantum circuits onto Quantum Execution Platform 990, or any other execution platform, to be executed thereby. In some cases, Quantum Execution Platform 990 may comprise a photonic quantum computer, a cloud of photonic quantum computers, or the like. In some cases, instead of executing synthesized quantum circuits, they may be simulated using an emulator, a simulator, or the like, on a classic computer.

The present disclosed subject matter may be a system, a method, and/or a computer program product. The computer program product may include a computer readable storage medium (or media) having computer readable program instructions thereon for causing a processor to carry out aspects of the present disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), electrical signals transmitted through a wire, Quantum Random Access Memory (QRAM), photons, trapped ions, lasers, cold atoms, or the like.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server (or a group of multiple remote servers). In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosed subject matter.

Aspects of the present disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description but is not intended to be exhaustive or limited to the disclosed subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method comprising:
obtaining a logical representation of a quantum program, wherein the logical representation comprises a plurality of logical qubits, wherein the logical representation defines a plurality of gate operations on subsets of the plurality of logical qubits;
converting the logical representation to a physical representation of the quantum program that is configured to be executed on a measurement-based quantum computer, wherein said converting comprises:
determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time;
selecting, for each segment of the plurality of disjoint segments, an interleaving depth from a plurality of interleaving depths supported by the measurement-based quantum computer, the plurality of interleaving depths corresponding to a respective plurality of lengths of delay lines between non-consecutive layers generated by each segment, wherein said selecting the interleaving depth comprises selecting a first interleaving depth for non-consecutive layers of a first segment of the plurality of disjoint segments, and selecting a second interleaving depth for non-consecutive layers of a second segment of the plurality of disjoint segments, the first and second interleaving depths are different, thereby obtaining a non-uniform distribution of interleaving depths between the plurality of disjoint segments; and
allocating, for each segment of the plurality of disjoint segments, one or more logical qubits of the plurality of logical qubits to be represented by the each segment, wherein said allocating the one or more logical qubits is performed based on interleaving depths of the plurality of disjoint segments; and
synthesizing the quantum program according to the physical representation, whereby a synthesized quantum program is executable on the measurement-based quantum computer.

2. The method of claim 1, wherein said allocating the one or more logical qubits comprises allocating, for a logical qubit of the plurality of logical qubits, a respective cluster ensemble from one or more non-consecutive layers generated by the first segment, the cluster ensemble comprises a set of clusters of physical qubits from the one or more non-consecutive layers, the one or more non-consecutive layers are interleaved according to the first interleaving depth.

3. The method of claim 2, wherein the one or more non-consecutive layers comprise a set of non-consecutive layers, wherein each two adjacent layers of the set are separated by at least one layer of clusters of physical qubits.

4. The method of claim 3, wherein the at least one layer of clusters comprises one of: a single layer, a pair of successive layers, or three successive layers.

5. The method of claim 3, wherein fusion operations are enabled between each two adjacent layers of the set due to the delay lines.

6. The method of claim 1, wherein said converting is performed according to an optimization function, wherein the optimization function is configured to minimize at least one of: a quantity of the plurality of quantum sources that are allocated to the plurality of disjoint segments, a number of cycles required for executing the synthesized quantum program on the measurement-based quantum computer, or an error rate of the synthesized quantum program.

7. The method of claim 1, wherein said converting comprises allocating fusion processes to implement the plurality of gate operations, the fusion processes comprising at least one of: fusion gates, or unitary gates, wherein the allocation of fusion processes affects a number of cycles required for executing the synthesized quantum program.

8. The method of claim 7, wherein said allocating the one or more logical qubits comprises allocating, for a first logical qubit of the plurality of logical qubits, a first cluster ensemble generated by the first segment, and allocating, for a second logical qubit of the plurality of logical qubits, a second cluster ensemble generated by the first segment, wherein said allocating the fusion processes comprises allocating a fusion process between the first and second cluster ensembles.

9. The method of claim 7, wherein said allocating the one or more logical qubits comprises allocating, for a first logical qubit of the plurality of logical qubits, a first cluster ensemble generated by the first segment, and allocating, for a second logical qubit of the plurality of logical qubits, a second cluster ensemble generated by a second segment, wherein said allocating the fusion processes comprises allocating a fusion process between the first and second cluster ensembles.

10. The method of claim 1, wherein said converting comprises allocating fusion processes to implement surface code measurements every defined period.

11. The method of claim 1, wherein the plurality of the lengths of the delay lines are longer for greater interleaving depths and shorter for lesser interleaving depths, wherein the delay lines comprise optical fibers.

12. The method of claim 1 further comprising executing the synthesized quantum program on the measurement-based quantum computer.

13. The method of claim 1, wherein the measurement-based quantum computer comprises a photonic quantum computer, and the physical qubits comprise optical qubits.

14. An apparatus comprising a processor and coupled memory, said processor being adapted to perform:
obtaining a logical representation of a quantum program, wherein the logical representation comprises a plurality of logical qubits, wherein the logical representation defines a plurality of gate operations on subsets of the plurality of logical qubits;
converting the logical representation to a physical representation of the quantum program that is configured to be executed on a measurement-based quantum computer, wherein said converting comprises:
determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time;
selecting, for each segment of the plurality of disjoint segments, an interleaving depth from a plurality of interleaving depths supported by the measurement-based quantum computer, the plurality of interleaving depths corresponding to a respective plurality of lengths of delay lines between non-consecutive layers generated by each segment, wherein said selecting the interleaving depth comprises selecting a first interleaving depth for non-consecutive layers of a first segment of the plurality of disjoint segments, and selecting a second interleaving depth for non-consecutive layers of a second segment of the plurality of disjoint segments, the first and second interleaving depths are different, thereby obtaining a non-uniform distribution of interleaving depths between the plurality of disjoint segments; and
allocating, for each segment of the plurality of disjoint segments, one or more logical qubits of the plurality of logical qubits to be represented by the each segment, wherein said allocating the one or more logical qubits is performed based on interleaving depths of the plurality of disjoint segments; and
synthesizing the quantum program according to the physical representation, whereby a synthesized quantum program is executable on the measurement-based quantum computer.

15. The apparatus of claim 14, wherein the first segment comprises a first numbers of quantum sources and the second segment comprises a second numbers of quantum sources, the first number of quantum sources different from the second number of quantum sources.

16. A method comprising:
obtaining a logical representation of a quantum program, wherein the logical representation comprises a plurality of logical qubits, wherein the logical representation defines a plurality of gate operations on subsets of the plurality of logical qubits;
converting the logical representation to a physical representation of the quantum program that is configured to be executed on a measurement-based quantum computer, wherein said converting is performed according to an optimization function, wherein said converting comprises:
determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time;
allocating, for each segment of the plurality of disjoint segments, one or more logical qubits of the plurality of logical qubits to be represented by the each segment, wherein said allocating comprises allocating, for a logical qubit of the plurality of logical qubits, a respective cluster ensemble, the cluster ensemble is generated by a segment of the plurality of disjoint segments, the cluster ensemble comprising a set of clusters of physical qubits; and
allocating fusion processes to implement the plurality of gate operations, wherein the fusion processes are scheduled to be performed between one or more cluster ensembles representing respective logical qubits, wherein the optimization function is configured to minimize a cost function, wherein the cost function measures a cost of the fusion processes, wherein the cost function measures a first cost for first fusion processes between clusters that are fused over space, wherein the cost function measures a second cost for second fusion processes between clusters that are fused over time, the first cost different from the second cost; and
synthesizing the quantum program according to the physical representation, whereby a synthesized quantum program is executable on the measurement-based quantum computer.

17. The method of claim 16, wherein the cost function is configured to measure at least one of: a quantity of the plurality of quantum sources that are allocated to the plurality of disjoint segments, a number of cycles required for executing the synthesized quantum program on the measurement-based quantum computer, or an error rate of the synthesized quantum program.

18. The method of claim 17, wherein the logical representation of the quantum program is configured to provide an output via one or more logical output qubits, wherein the error rate of the synthesized quantum program comprises error rates of the one or more logical output qubits.

19. The method of claim 17, wherein the fusion processes comprise at least one of:
fusion gates or unitary gates, wherein the allocation of fusion processes affects the number of cycles.

20. The method of claim 16, wherein the cost function is configured to measure costs according to a weighting scheme that allocates different weights to different resources.

21. The method of claim 20, wherein the weighting scheme is obtained from a user.

22. The method of claim 16, wherein said allocating the one or more logical qubits comprises allocating, for a second logical qubit of the plurality of logical qubits, a second cluster ensemble, wherein said allocating the fusion processes comprises allocating a fusion process between the first and second cluster ensembles.

23. The method of claim 22, wherein the second cluster ensemble is generated by the segment or by a different segment of the plurality of disjoint segments.

24. The method of claim 16 further comprising determining to dynamically adjust an allocation of resources determined by said converting, whereby the allocation of resources is dynamically adjusted during an execution of the synthesized quantum program, wherein the cost function is configured to measure a cost of said dynamically adjusting.

25. The method of claim 16, wherein said determining the segmentation comprises determining, for each of the plurality of disjoint segments, at least one of: a number of quantum sources allocated thereto, and a dynamic adjustment of the number.

26. The method of claim 16, wherein said converting comprises allocating fusion processes to implement surface code measurements every defined period.

27. The method of claim 16, wherein:
the optimization function defines a Constraint Satisfaction Problem (CSP) that corresponds to the quantum program, the CSP comprises variables, domains and constraints, each variable of the variables has a corresponding domain in the domains that defines one or more potential values of the variable, the constraints define one or more constraints on values of the variables or portion thereof; and
the method further comprises generating the synthesized quantum program by utilizing a CSP solver to solve the CSP, wherein a solution of the CSP defines the synthesized quantum program.

28. The method of claim 27, wherein the logical representation of the quantum program comprises a Directed Acyclic Graph (DAG), wherein nodes of the DAG represent the plurality of gate operations, wherein edges between the nodes represent precedence constraints between the plurality of gate operations, wherein the constraints of the CSP comprise the precedence constraints.

29. The method of claim 16 further comprising executing the synthesized quantum program on the measurement-based quantum computer.

30. A computer program product comprising a non-transitory computer readable medium retaining program instructions, which program instructions when read by a processor, cause the processor to perform:
obtaining a logical representation of a quantum program, wherein the logical representation comprises a plurality of logical qubits, wherein the logical representation defines a plurality of gate operations on subsets of the plurality of logical qubits;
converting the logical representation to a physical representation of the quantum program that is configured to be executed on a measurement-based quantum computer, wherein said converting is performed according to an optimization function, wherein said converting comprises:
determining a segmentation of a plurality of quantum sources of the measurement-based quantum computer into a plurality of disjoint segments, wherein the plurality of disjoint segments is configured to generate consecutive layers of clusters of physical qubits, respectively, the consecutive layers are separated by respective time delays, wherein each segment is configured to periodically generate one layer of clusters at a time;
allocating, for each segment of the plurality of disjoint segments, one or more logical qubits of the plurality of logical qubits to be represented by the each segment, wherein said allocating comprises allocating, for a logical qubit of the plurality of logical qubits, a respective cluster ensemble, the cluster ensemble is generated by a segment of the plurality of disjoint segments, the cluster ensemble comprising a set of clusters of physical qubits; and
allocating fusion processes to implement the plurality of gate operations, wherein the fusion processes are scheduled to be performed between one or more cluster ensembles representing respective logical qubits, wherein the optimization function is configured to minimize a cost function, wherein the cost function measures a cost of the fusion processes, wherein the cost function measures a first cost for first fusion processes between clusters that are fused over space, wherein the cost function measures a second cost for second fusion processes between clusters that are fused over time, the first cost different from the second cost; and
synthesizing the quantum program according to the physical representation, whereby a synthesized quantum program is executable on the measurement-based quantum computer.

31. The computer program product of claim 30, wherein the measurement-based quantum computer comprises a photonic quantum computer, and the physical qubits comprise optical qubits.
